(19) United States
(12) Patent Application Publication
(10) Pub. No.: US 2025/0307468 A1
(43) Pub. Date: Oct. 2, 2025

(54) SERVICE PROVIDING METHOD USING ACCESS CARD, SERVICE FILTERING METHOD, AND DEVICE FOR PERFORMING SAME

(71) Applicant: KAKAO CORP., Jeju-si (KR)

(72) Inventors: Hyeon Su JEON, Seongnam-si (KR); Yong Woon LEE, Seongnam-si (KR); Jeong Ho KIM, Seongnam-si (KR); Geun Tak HAN, Seongnam-si (KR); Bit Na PAK, Seongnam-si (KR); Na Yeong HONG, Seongnam-si (KR); An Na CHO, Seongnam-si (KR); Ji Hyun KIM, Seongnam-si (KR)

(21) Appl. No.: 18/562,272

(22) PCT Filed: May 18, 2022
(86) PCT No.: PCT/KR2022/007103

§ 371 Date: Sep. 11, 2024

(30) Foreign Application Priority Data
May 18, 2021 (KR) 10-2021-0064355
May 18, 2021 (KR) 10-2021-0064393
May 13, 2022 (KR) 10-2022-0059199

(51) Int. Cl. G06F 21/62; G06F 21/44

(52) U.S. Cl. CPC G06F 21/629; G06F 21/44

(57) ABSTRACT

Disclosed are a service providing method using an access card, a service filtering method, and a device for performing same. The service providing method using an access card relates to a method in which a filtering condition is set in an application service by an account of a partner terminal, and the application service can be used when an access card issued to a user terminal meets the filtering condition. The service filtering method using an access card relates to a method in which a processing result for the application service is determined on the basis of the filtering condition set in the application service by the partner terminal and the access card issued to the user terminal.

### BACKGROUND

### Technical Field

The following disclosure relates to a service providing method and a service filtering method using an access card, and an apparatus for performing the method.

### Description of the Related Art

A user engages in various activities through online and offline areas. For example, a user arrives at work at 9 AM, enters an office by tagging an employee card, works out at 12 PM by providing a membership card as a member of a gym center, purchases a ticket on an online website at 6 PM, chats with friends in a chatroom at 7 PM, and leaves the office at 9 PM and passes an entrance of an apartment by tagging an entry card to the entrance.

In this case, when a user logs in an online area or a user enters an offline area, a user may need a requirement of a specific qualification to access. There is a demand for a bulk management method of an access qualification for various online or offline activities through a user terminal.

### BRIEF SUMMARY

### Technical Goals

The present disclosure provides a method and apparatus for easily and conveniently issuing and managing an access card required by a user to access online or offline through an application.

The present disclosure provides a method and apparatus for accessing a specific online or offline area related to a partner through a required access card by managing an access card created by the partner in an application installed in a user terminal.

The present disclosure provides a method and apparatus for increasing utilization of an access card by differently processing the availability of a service subscribed with account information of a partner terminal creating an access card, based on a retention status of the access card.

The present disclosure provides a method and apparatus for filtering an access to a service by differently providing an available function or content in a service depending on a type of an access card issued to a user terminal.

### Technical Solutions

According to one embodiment of the present disclosure, a service providing method, performed by an access card management server, using an access card, the service providing method includes creating at least one access card by an account of a partner terminal, issuing the at least one created access card to a user terminal, receiving, from a service providing server, a view request of a list of access cards to which the account of the partner terminal has permission, transmitting the list of access cards to which the account has permission to the service providing server, receiving, from the service providing server, a confirmation request of an access card issued to the user terminal to provide an application service requested by the user terminal, and transmitting information on the access card issued to the user terminal to the service providing server, wherein a filtering condition related to an access card is set to an application service by the account of the partner terminal, and the application service is provided to the user terminal based on whether the access card issued to the user terminal satisfies the filtering condition.

The application service is a service subscribed by the partner terminal with the account, wherein the partner terminal subscribes to an access card issuance service with the account.

The filtering condition set to the application service includes a condition related to, whether all access cards issued to the user terminal are the same as the at least one access card set to the application service, whether at least one of access cards issued to the user terminal is the same as the at least one access card set to the application service, or whether all access cards issued to the user terminal are different from the at least one access card set to the application service.

The filtering condition set to the application service is set to each of one or more detailed functions supported by the application service.

The application service includes a messaging service, and the detailed function includes at least one of (i) a function to enter a chatroom of the messaging service, (ii) a function to use a chatbot in a chatroom of the messaging service, (iii) a function to highlight a chat message in a chatroom, (iv) a function to post an announcement in a chatroom, (v) a function to search or share a search result in a chatroom, (vi) a function to share content in a chatroom, and (vii) a function to use an additional service accessible through the messaging service.

The application service includes a video service, and the detailed function includes at least one of (i) a function to skip an advertisement inserted in the middle of a video, (ii) a function to share a video, (iii) a function to watch a video, and (iv) a function to download or edit a video.

The application service includes a social network service, and the detailed function includes at least one of (i) a function to add a friend, (ii) a function to upload or download content, and (iii) a function to chat with a friend.

According to one embodiment of the present disclosure, a service providing method, performed by a service providing server, using an access card, the service providing method includes transmitting, to an access card management server, a view request of a list of access cards to which an account of a partner terminal has permission, receiving, from the access card management server, the list of access cards to which the account has permission, setting a filtering condition for an application service using the list of access cards, receiving a provision request of an application service from a user terminal, transmitting, to the access card management server, a confirmation request of an access card issued to the user terminal, receiving information on the access card issued to the user terminal from the access card management server, determining whether the access card issued to the user terminal satisfies the filtering condition set to the application service, and providing the application service to the user terminal based on whether the access card issued to the user terminal satisfies the filtering condition set to the application service, wherein a filtering condition related to an access card is set to an application service by the account of the partner terminal.

The application service is a service subscribed by the partner terminal with the account, wherein the partner terminal subscribes to an access card issuance service with the account.

The filtering condition set to the application service includes a condition related to, whether all access cards issued to the user terminal are the same as the at least one access card set to the application service, whether at least one of access cards issued to the user terminal is the same as the at least one access card set to the application service, or whether all access cards issued to the user terminal are different from the at least one access card set to the application service.

The filtering condition set to the application service is set to each of at least one detailed function supported by the application service.

The application service includes a messaging service, and the detailed function includes at least one of (i) a function to enter a chatroom of the messaging service, (ii) a function to use a chatbot in a chatroom of the messaging service, (iii) a function to highlight a chat message in a chatroom, (iv) a function to post an announcement in a chatroom, (v) a function to search or share a search result in a chatroom, (vi) a function to share content (an image, a video, a link, and the like) in a chatroom, and (vii) a function to use an additional service accessible through the messaging service.

The application service includes a video service, and the detailed function includes at least one of (i) a function to skip an advertisement inserted in the middle of a video, (ii) a function to share a video, (iii) a function to watch a video, and (iv) a function to download or edit a video.

The application service includes a social network service, and the detailed function includes at least one of (i) a function to add a friend, (ii) a function to upload or download content, and (iii) a function to chat with a friend.

According to one embodiment of the present disclosure, a service providing method, performed by a user terminal, using an access card, the service providing method includes being issued and retaining an access card created with an account of a partner terminal from an access card management server, transmitting a provision request for an application service to a service providing server, and receiving a provision response of the application service from the service providing server, wherein a filtering condition related to an access card is set to an application service by the account of the partner terminal, and the application service is provided to the user terminal based on whether the access card issued to the user terminal satisfies the filtering condition.

The application service is a service subscribed by the partner terminal with the account, wherein the partner terminal subscribes to an access card issuance service with the account.

The filtering condition set to the application service includes a condition related to, whether all access cards issued to the user terminal are the same as the at least one access card set to the application service, whether at least one of access cards issued to the user terminal is the same as the at least one access card set to the application service, or whether all access cards issued to the user terminal are different from the at least one access card set to the application service.

According to one embodiment of the present disclosure, a service filtering method, performed by an access card management server, using an access card, the service providing method includes receiving card information to create an access card from a partner terminal, creating an access card based on the received card information, issuing the created access card to a user terminal, receiving a view request of the access card issued to the user terminal from a service providing server providing an application service, and in response to the view request, transmitting a view response of the access card issued to the user terminal to the service providing server, wherein the application service is provided to the user terminal based on a filtering condition set to the application service and the access card issued to the user terminal, and the filtering condition includes a filtering condition for a service function supported by the application service or a filtering condition for content provided through the application service.

The filtering condition includes at least one of retention of the access card, a combination of access cards, permission set to the access card, the number of access cards, or a type of the access card.

The application service includes a messaging service, and a service function of the application service includes at least one of (i) a function to enter a chatroom of the messaging service, (ii) a function to use a chatbot in a chatroom of the messaging service, (iii) a function to highlight a chat message in the chatroom, or (iv) a function to post an announcement in the chatroom.

The application service includes a video service, and whether content of the video service is allowed to be watched in the user terminal is determined based on the access card issued to the user terminal.

The application service includes a social network service, and whether content of the social network service is allowed to be viewed, uploaded, or downloaded in the user terminal is determined based on the access card issued to the user terminal.

According to one embodiment of the present disclosure, a service filtering method, performed by a service providing server, using an access card, the service providing method includes receiving a filtering condition for an application service from a partner terminal, receiving a process request for the application service from a user terminal, in response to the process request, transmitting a view request of an access card issued to the user terminal to an access card management server creating the access card, in response to the view request, receiving a view response including information on the access card issued to the user terminal from the access card management server, and providing, to the user terminal, a process response to the application service based on a filtering condition set to the application service and the access card issued to the user terminal, wherein the filtering condition includes a filtering condition for a service function supported by the application service or a filtering condition for content provided through the application service.

The filtering condition includes at least one of retention of an access card, a combination of access cards, permission set to an access card, the number of access cards, or a type of an access card.

The application service includes a messaging service, and a service function of the application service includes at least one of (i) a function to enter a chatroom of the messaging service, (ii) a function to use a chatbot in a chatroom of the messaging service, (iii) a function to highlight a chat message in the chatroom, or (iv) a function to post an announcement in the chatroom.

The application service includes a video service, and whether content of the video service is allowed to be watched in the user terminal is determined based on the access card issued to the user terminal.

The application service includes a social network service, and whether content of the social network service is allowed to be viewed, uploaded, or downloaded in the user terminal is determined based on the access card issued to the user terminal.

According to one embodiment of the present disclosure, a service providing method, performed by a user terminal, using an access card, the service providing method includes issuing an access card created by a partner terminal from an access card management server, transmitting a process request for an application service to a service providing server, and receiving a process response to the application service from the service providing server, wherein the process response is determined based on a filtering condition set to the application service and an access card issued to the user terminal, and the filtering condition includes a filtering condition for a service function supported by the application service or a filtering condition for content provided through the application service.

The filtering condition includes at least one of retention of an access card, a combination of access cards, permission set to an access card, the number of access cards, or a type of an access card.

### Effects

According to one embodiment of the present disclosure, an access card required by a user to access online or offline may be easily and conveniently managed through an application.

According to one embodiment of the present disclosure, a specific online or offline area related to a partner may be accessed through a required access card by managing an access card created by the partner in an application installed in a user terminal.

According to one embodiment of the present disclosure, utilization of an access card may increase by differently processing the availability of a service subscribed with account information of a partner terminal creating an access card, based on a retention status of the access card.

According to one embodiment of the present disclosure, an access to a service may be filtered by differently providing an available function or content in a service depending on a type of an access card issued to a user terminal.

### BRIEF DESCRIPTION OF THE SEVERAL VIEWS OF THE DRAWINGS

FIG. 1 is a diagram illustrating operations of apparatuses for performing a method of providing an access card according to a first embodiment of the present disclosure.

FIG. 2 is a diagram illustrating a process of providing an access card according to the first embodiment of the present disclosure.

FIG. 3 is a flowchart illustrating a process of performing a method of providing an access card according to the first embodiment of the present disclosure.

FIG. 4 is a diagram illustrating operations of apparatuses for performing a method of providing an access card according to a second embodiment of the present disclosure.

FIG. 5 is a diagram illustrating a process of providing an access card according to the second embodiment of the present disclosure.

FIG. 6 is a flowchart illustrating a process of performing a method of providing an access card according to the second embodiment of the present disclosure.

FIG. 7 is a diagram illustrating a partner management page accessed by a partner terminal according to one embodiment of the present disclosure.

FIG. 8 is a diagram illustrating a card creation page accessed by a partner terminal according to one embodiment of the present disclosure.

FIG. 9 is a diagram illustrating a card management page accessed by a partner terminal according to one embodiment of the present disclosure.

FIG. 10 is a diagram illustrating an example in which a user terminal accesses a card issuance page according to one embodiment of the present disclosure.

FIG. 11 is a diagram illustrating an example in which a user terminal issues an access card through an application according to one embodiment of the present disclosure.

FIG. 12 is a diagram illustrating an example in which a user terminal manages an access card through an application according to one embodiment of the present disclosure.

FIG. 13 is a diagram illustrating an example in which an access card is used through a plurality of user terminals according to one embodiment of the present disclosure.

FIG. 14 is a diagram illustrating an example of generating an access card corresponding to a partner package according to one embodiment of the present disclosure.

FIG. 15 is a diagram illustrating an apparatus for performing a service providing method and a service filtering method using an access card according to one embodiment of the present disclosure.

FIG. 16 is a flowchart of a service providing method using an access card according to one embodiment of the present disclosure.

FIG. 17 is a diagram illustrating a process of determining whether a service is provided based on a first condition set to an application service and an access card issued to a user terminal according to one embodiment of the present disclosure.

FIG. 18 is a diagram illustrating a process of determining whether a service is provided based on a second condition set to an application service and an access card issued to a user terminal according to one embodiment of the present disclosure.

FIG. 19 is a diagram illustrating a process of determining whether a service is provided based on a third condition set to an application service and an access card issued to a user terminal according to one embodiment of the present disclosure.

FIG. 20 is a diagram illustrating an example of differently setting conditions to a plurality of application services, according to one embodiment of the present disclosure

FIG. 21 is a flowchart illustrating a service filtering method according to one embodiment of the present disclosure.

FIG. 22 is a diagram illustrating a service filtering method related to a service function of an application service according to one embodiment of the present disclosure.

FIG. 23 is a diagram illustrating a service filtering method related to content provided by an application service according to one embodiment of the present disclosure.

FIG. 24 is a diagram illustrating an example in which, when an application service is a chat service, an entry status to a chatroom varies depending on an issuance of an access card to a user terminal, according to one embodiment of the present disclosure.

FIG. 25 is a diagram illustrating an example in which, when an application service is a chatbot service, a response message varies depending on an issuance of an access card to a user terminal, according to one embodiment of the present disclosure.

FIG. 26 is a diagram illustrating an example in which an access availability to content provided by an application service varies depending on an issuance of an access card to a user terminal, according to one embodiment of the present disclosure.

### DETAILED DESCRIPTION

Hereinafter, examples will be described in detail with reference to the accompanying drawings. The scope of the right, however, should not be construed as limited to the example embodiments set forth herein. In the drawings, like reference numerals are used for like elements.

Various modifications may be made to the examples. Here, the examples are not construed as limited to the disclosure and should be understood to include all changes, equivalents, and replacements within the idea and the technical scope of the disclosure.

Although terms of “first” or “second” are used to explain various components, the components are not limited to the terms. These terms should be used only to distinguish one component from another component. For example, a first component may be referred to as a second component, and similarly the second component may also be referred to as the first component.

The terminology used herein is for the purpose of describing particular examples only and is not to be limiting of the examples. As used herein, the singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the examples with reference to the accompanying drawings, like reference numerals refer to like constituent elements and a repeated description related thereto will be omitted. In the description of example embodiments, detailed description of well-known related structures or functions will be omitted when it is deemed that such description will cause ambiguous interpretation of the present disclosure.

Hereinafter, example embodiments will be described in detail with reference to the accompanying drawings.

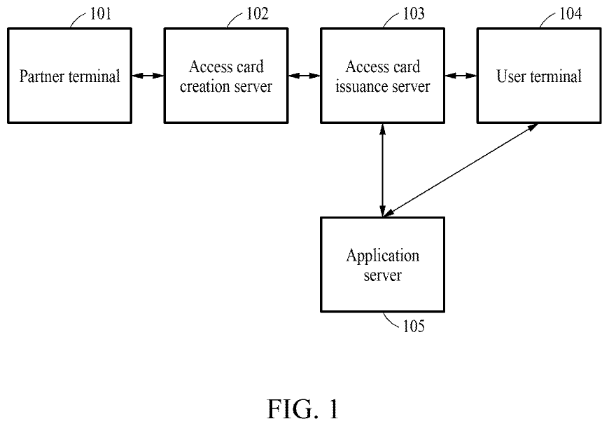

FIG. 1 is a diagram illustrating operations of apparatuses for performing a method of providing an access card according to a first embodiment of the present disclosure.

FIG. 1 shows a partner terminal 101, an access card creation server 102, an access card issuance server 103, a user terminal 104, and an application server 105. The partner terminal 101 may create an access card through the access card creation server 102 for online or offline access of a user holding the user terminal 104. The creation of the access card may be performed through an access card creation page provided by the access card creation server 102.

The access card may be provided to the user terminal 104 that has accessed an access card issuance page provided by the access card issuance server 103. Alternatively, the access card may be provided through an application linked to the access card issuance server 103. In this case, the application may be installed on the user terminal 104 to operate in association with the application server 105 and provide a link or menu so that the user terminal 104 may access the access card issuance page.

According to one embodiment of the present disclosure, the partner terminal 101 may provide, to the user terminal 104, an access card which is a virtual card corresponding to a valid identity, qualification, company, school, membership, access card, warranty card, business card, ticket, and admission ticket, without the use of offline means for the user terminal 104.

In FIG. 1, the access card creation server 102, the access card issuance server 103, and the application server 105 may be operated by the same business entity or by different business entities.

An access card may refer to a virtual card including information on qualifications to enter a specific online area (e.g., a website or application) related to a partner through login or to enter a specific offline space (e.g., a building) related to a partner. The access card may refer to a virtual card that allows the user terminal 104 to access or enter an online or offline area related to the partner.

In other words, the access card may be a digitized virtual card of an online or offline valid identity, qualification, company, school, membership, access card, warranty card, business card, ticket, or entry ticket. The partner terminal 101 may create an access card which is a virtual card that digitizes and represents identity, rights, qualifications, ownership, or access rights confirmed online or offline in a cloud type service.

The access cards may be divided into various types. For example, the access card may be a card used to prove identity or affiliation related to a partner, such as a student identification (ID) card, employee ID card, membership card, business card, or ID card. Alternatively, the access card may be an admission ticket to watch a performance, exhibition, or game related to the partner taking place at a specific time. The access card may be a membership, season ticket, or the like related to the partner that may be used in a specific period. Alternatively, the access card may refer to a card to enter a building designated by the partner, or may be information for authentication of purchase/possession of products or services related to the partner, such as a warranty. The access card described above refers to information that may prove whether the user has permission to access an online or offline area related to the partner, and is not limited to the examples described above.

For example, in order for the user to enter a chatroom generated by the partner, the user terminal 104 may receive an access card, which is permission to enter the chatroom through the card issuance page of the access card issuance server 103. In another example, in order for the user to visit a specific space (office) of the partner, the user terminal 104 may receive an access card, which is permission to enter the office through the card issuance page of the access card issuance server 103. The access card issued through the card issuance page of the access card issuance server 103 may be stored in at least one of the access card creation server 102, the access card issuance server 103, the application server 105, or the user terminal 104.

The access card creation server 102 may provide an access card creation page, which is an interface through which the partner terminal 101, that wishes to create an access card, may sign up, register, and then create an access card. The access card issuance server 103 may provide an access card issuance page, which is an interface through which the user terminal 104, that wishes to receive an access card, may access and receive the access card. The user terminal 104 may access the access card issuance page through an application provided by the application server 105 and transmit a request for issuance of an access card. After the access card is issued, the user terminal 104 may manage the access card through the application. In an example, the application may be a messenger application.

As an access check device (not shown) connected to the partner terminal 101 checks whether the access card exists for the user terminal 104, the user may enter a specific offline space related to the partner. The user terminal 104 and the access check device may use a short-range wireless method (e.g., Bluetooth, near-field communication (NFC), etc.), the access check device may read identification information (e.g., a quick-response (QR) code) displayed on the user terminal 104, or the user terminal 104 may read identification information displayed on the access check device, to check whether the access card exists in the application installed on the user terminal 104.

According to one embodiment of the present disclosure, the user terminal 104 may be conveniently accessed by managing an access card required for various online or offline activities through an application installed in the user terminal 104.

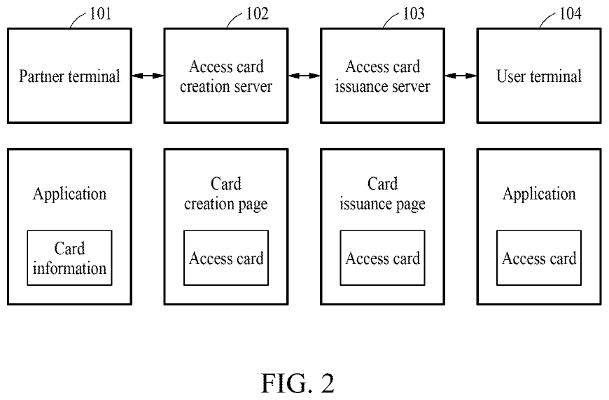

FIG. 2 is a diagram illustrating a process of providing an access card according to the first embodiment of the present disclosure.

FIG. 2 shows a process in which an access card created by the partner terminal 101 in the access card creation server 102 is issued to the user terminal 104 that has accessed the access card issuance server 103.

The partner terminal 101 related to the partner may register the partner on the card creation page provided by the access card creation server 102, and create an access card related to the partner. The card creation page may provide an interface through which information on a partner is registered and the partner terminal 101 may input card information expressed as an image or a text to create an access card.

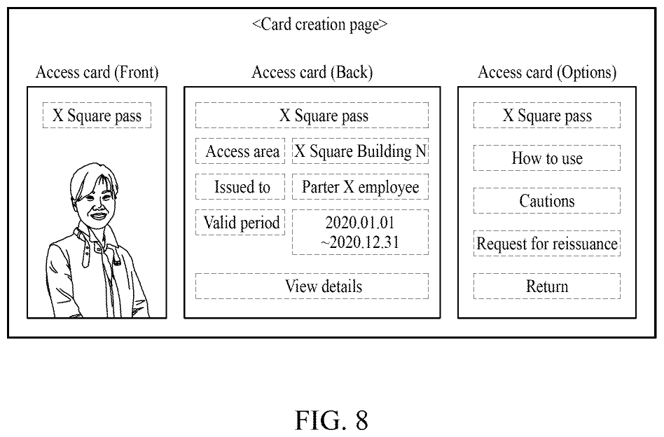

The partner terminal 101 may use an application installed on the partner terminal 101 to access the card creation page. The partner terminal 101 may create an access card by inputting the card information for creating the access card to the card creation page. The card information will be described in detail with reference to FIG. 8.

When the creation of the access card is completed in the access card creation server 102, an instant message including a notification that the creation of the access card is completed or information on the access card created based on the card information may be provided to the partner terminal 101 through a messenger application. In this case, the message may be provided through a chatroom in which a business entity corresponding to the partner terminal 101 participates or a chatroom in which a business entity corresponding to the access card creation server 102 participates. A chatroom in which a business entity participates may be expressed by a business entity's name or icon.

The access card created by the access card creation server 102 may be provided to the user terminal 104 through the card issuance page provided by the access card issuance server 103. The card issuance page is accessible through a link (a Uniform Resource Locator (URL)) or a QR code. The link or the QR code for accessing the card issuance page may be provided to the user terminal 104 directly by the partner terminal 101, or may be provided to the user terminal 104 through the access card creation server 102 or the access card issuance server 103.

The user terminal 104 may access the card issuance page through the link or the QR code for accessing the card issuance page, and receive the access card issued on the card issuance page through an application. A message notifying whether the access card is issued may be provided to the partner terminal 101 through an application.

When the issuance of the access card is completed by the access card issuance server 103, an instant message including a notification that the issuance of the access card is completed may be provided to the partner terminal 101 or the user terminal 104 through a messenger application. In this case, the message may be provided through a chatroom in which a business entity corresponding to the partner terminal 101 participates or a chatroom in which a business entity corresponding to the access card issuance server 103 participates. A chatroom in which a business entity participates may be expressed by a business entity's name or icon.

The access card may be generated in response to user information. The user information is information for identifying a user and may include a phone number of the user terminal 104 or account information (ID) of an application installed on the user terminal 104.

The access card may be stored in an application installed on the user terminal 104, or may be stored in the access card issuance server 103 rather than the user terminal 104, and the user terminal 104 may check it through the application.

The access card may be stored by various methods. In an example, when the access card is created by the access card creation server 102, the access card may be stored in a secure storage area of the access card creation server 102 or the access card issuance server 103. In this case, the consent of the user terminal 104 may be required for the access card to be stored in the secure storage area of the access card creation server 102 or the access card issuance server 103. In this case, the access card may not be stored in the user terminal 104, and a list of access cards issued to the partner may be provided through an application installed on the user terminal 104. After that, when a specific area of the partner is accessed online or offline through the user terminal 104, the user terminal 104 may download the access card from the secure storage area of the access card creation server 102 or the access card issuance server 103 and store the access card. Alternatively, when a specific area of the partner is accessed online or offline through the user terminal 104, the access card may not be downloaded to the user terminal 104, and it may be confirmed whether the access card stored in the secure storage area of the access card creation server 102 or the access card issuance server 103 exists through the user information corresponding to the access card.

In another example, when the access card is generated by the access card creation server 102, the access card may be downloaded to the user terminal 104 and managed through an application. That is, the access card may be encoded and stored in a storage area of the user terminal 104. When a specific area of the partner is accessed online or offline through the user terminal 104, it may be confirmed whether the access card exists by decoding the encoded access card through a certificate of the user terminal 104.

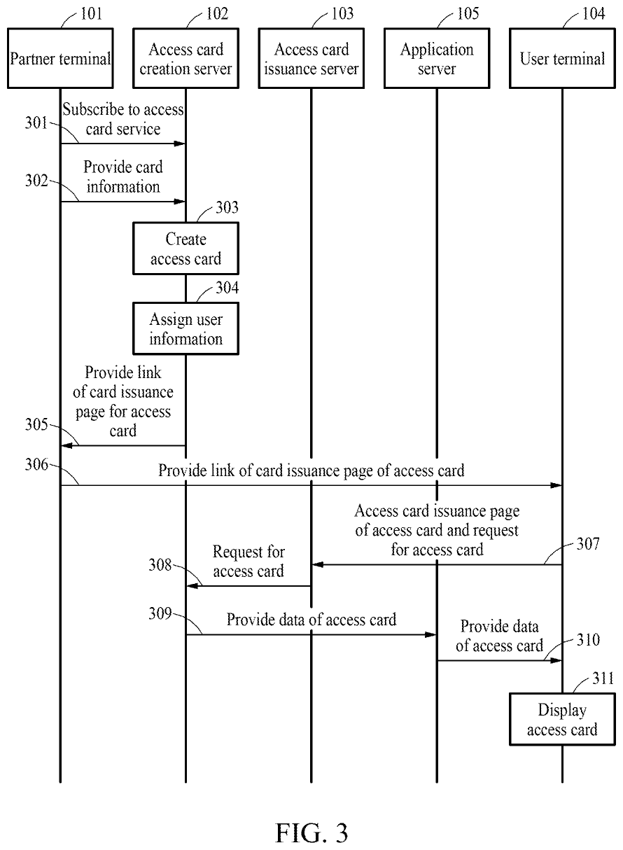

FIG. 3 is a flowchart illustrating a process of performing a method of providing an access card according to the first embodiment of the present disclosure.

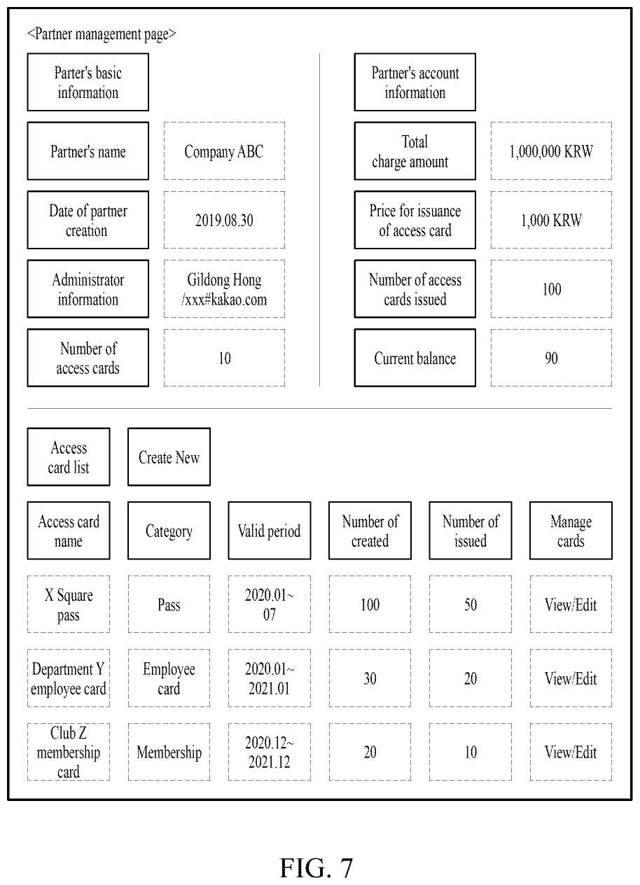

In operation 301, the partner terminal 101 may subscribe to an access card service through a partner management page provided by the access card creation server 102. Information input when subscribing to the access card service will be described in detail with reference to FIG. 7.

In operation 302, the partner terminal 101 may provide card information to a card creation page provided by the access card creation server 102. The card information will be described in detail with reference to FIG. 8.

In operation 303, the access card creation server 102 may create an access card based on the card information input by the partner terminal 101. The card information transmitted to or registered in the access card creation server 102 by the partner terminal 101 to create an access card will be described in more detail with reference to FIG. 8.

In operation 304, the access card creation server 102 may assign user information of the user terminal 104 to the access card. For example, when the access card is issued limitedly to a specific user terminal 104, the user information may be assigned to the access card. Although not shown in FIG. 3, when the user terminal 104 to which the access card is issued is not designated, a count of available issuances of the access card in the order of application may be assigned to the access card.

In operation 305, the access card creation server 102 may provide a link to the card issuance page for the access card to the partner terminal 101.

In operation 306, the partner terminal 101 may provide a link to the card issuance page of the access card to the user terminal 104.

In operation 307, the user terminal 104 may access the card issuance page of the access card and request for the issuance of the access card to the access card issuance server 103.

In operation 308, the access card issuance server 103 may request the access card to the access card creation server 102.

In operation 309, the access card creation server 102 may provide data for the access card to the application server 105. An actually created access card may be stored in the access card creation server 102, and the data for the access card required to display the access card may be provided to the application server 105.

In operation 310, the application server 105 may provide the data for the access card to the user terminal 104.

In operation 311, the user terminal 104 may display the access card through an application using the data for the access card.

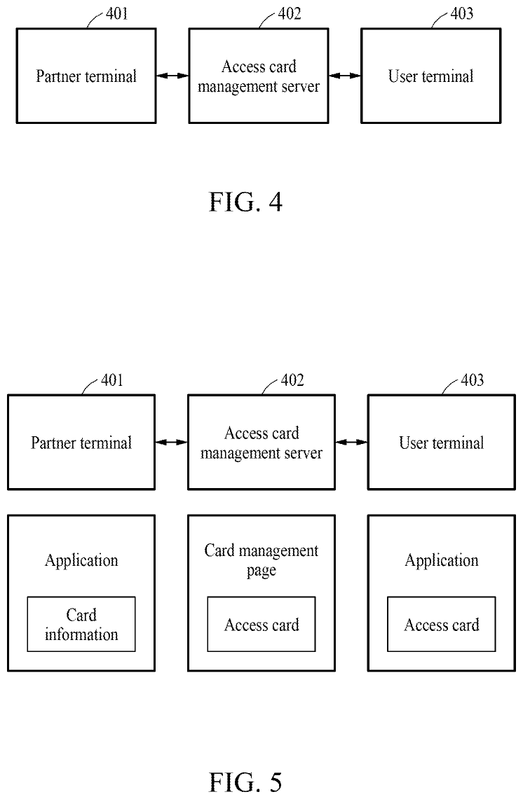

FIG. 4 is a diagram illustrating operations of apparatuses for performing a method of providing an access card according to a second embodiment of the present disclosure.

FIG. 4 shows a case where the access card creation server 102, the access card issuance server 103, and the application server 105 described with reference to FIG. 1 are implemented through an access card management server 402, which is one server. The access card management server 402 may perform the same operations as those of the access card creation server 102, the access card issuance server 103, and the application server 105. An operation of a partner terminal 401 may be the same as the operation of the partner terminal 101, and an operation of a user terminal 403 may be the same as the operation of the user terminal 104.

The partner terminal 101 may create an access card through the access card management server 402 for online or offline access of a user holding the user terminal 104. The creation of the access card may be performed through an access card creation page provided by the access card management server 402. The access card may be provided to the user terminal 403 that has accessed an access card issuance page provided by the access card management server 402 through an application.

FIG. 5 is a diagram illustrating a process of providing an access card according to the second embodiment of the present disclosure.

Specifically, FIG. 5 shows a process in which an access card created by the partner terminal 401 in the access card management server 402 is issued to the user terminal 403 that has accessed the access card management server 402.

The partner terminal 401 related to a partner may register the partner on the card creation page provided by the access card management server 402, and create an access card related to the partner. The card creation page may provide an interface through which information on a partner is registered and the partner terminal 401 may input card information expressed as an image or a text to create an access card. The card information transmitted to or registered in the access card management server 402 by the partner terminal 401 to create an access card will be described in more detail with reference to FIG. 8.

The partner terminal 401 may use an application installed on the partner terminal 401 to access the card creation page. The partner terminal 401 may create an access card by inputting the card information for creating the access card to the card creation page.

When the creation of the access card is completed in the access card management server 402, an instant message including a notification that the creation of the access card is completed or information on the access card created based on the card information may be provided to the partner terminal 401 through a messenger application. In this case, the message may be provided through a chatroom in which a business entity corresponding to the partner terminal 401 participates or a chatroom in which a business entity corresponding to the access card management server 402 participates. A chatroom in which a business entity participates may be expressed by a business entity's name or icon.

The access card created by the access card management server 402 may be provided to the user terminal 403 through the card issuance page. The user terminal 403 may access the card issuance page through a link (URL) or a QR code. The link or the QR code for accessing the card issuance page may be provided to the user terminal 403 directly by the partner terminal 401, or may be provided to the user terminal 403 through the access card management server 402.

The user terminal 403 may access the card issuance page through the link or the QR code for accessing the card issuance page, and receive the access card issued on the card issuance page through an application. A message notifying whether the access card is issued may be provided to the partner terminal 401 through an application.

When the issuance of the access card is completed by the access card management server 402, an instant message including a notification that the issuance of the access card is completed may be provided to the partner terminal 401 or the user terminal 403 through a messenger application. In this case, the message may be provided through a chatroom in which a business entity corresponding to the partner terminal 401 participates or a chatroom in which a business entity corresponding to the access card management server 402 participates. A chatroom in which a business entity participates may be expressed by a business entity's name or icon.

When the access card is generated, user information may be assigned to the access card. The user information is information for identifying a user and may include a phone number of the user terminal 403, account information (ID) of an application installed on the user terminal 403, or identification information (employment number/student number, etc.) of another user.

The access card may be stored in an application installed on the user terminal 403, or may be stored in the access card management server 402 rather than the user terminal 403, and the user terminal 403 may check it through the application.

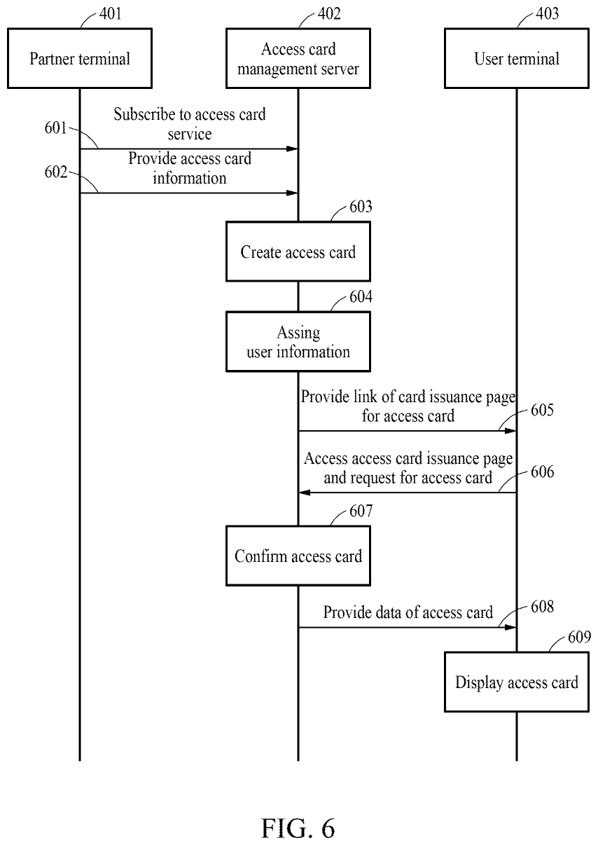

FIG. 6 is a flowchart illustrating a process of performing a method of providing an access card according to the second embodiment of the present disclosure.

In operation 601, the partner terminal 401 may subscribe to an access card service through a partner management page provided by the access card management server 402. Information input when subscribing to the access card service will be described in detail with reference to FIG. 7.

In operation 602, the partner terminal 101 may provide card information to a card creation page provided by the access card management server 402. The card information will be described in detail with reference to FIG. 8.

In operation 603, the access card management server 402 may create an access card based on the card information input by the partner terminal 401.

In operation 604, the access card management server 402 may assign user information of the user terminal 403 to the access card. For example, when the access card is issued limitedly to a specific user terminal 403, the user information may be assigned to the access card. Although not shown in FIG. 6, when the user terminal 403 to which the access card is issued is not designated, a count of available issuances of the access card in the order of application may be assigned to the access card.

In operation 605, the access card management server 402 may provide a link to the card issuance page for the access card to the user terminal 403.

In operation 606, the user terminal 403 may access the card issuance page of the access card and request for the issuance of the access card to the access card management server 402.

In operation 607, the access card management server 402 may confirm the access card requested to be issued by the user terminal 403.

In operation 608, the access card management server 402 may provide data for the access card to the user terminal 403. An actually created access card may be stored in the access card management server 402, and the data for the access card required to display the access card may be provided to the user terminal 403. Alternatively, the data for the access card may be stored in the user terminal 403.

In operation 609, the user terminal 104 may display the access card through an application using the data for the access card.

A partner management page and a card creation page to be described with reference to FIGS. 7 to 14 may be provided by the access card creation server 102 or the access card management server 402. Also, a card issuance page may be provided by the access card issuance server 103 or the access card management server 402. FIGS. 7 to 14 describe the partner terminal 101 and the user terminal 104.

FIG. 7 is a diagram illustrating a partner management page accessed by a partner terminal according to one embodiment of the present disclosure.

The partner management page shown in FIG. 7 may refer to a page for the partner terminal 101 to sign up to create an access card or to manage the access card after signing up.

The partner terminal 101 may register a name of a partner and administrator information to create an access card. According to one embodiment of the present disclosure, the issuance of an access card may charge a fee. Account information for the partner may be set for the charging. The account information may include a recharge amount, price for the issuance of an access card, the number of access cards issued, current balance, and the like. The recharge amount refers to the amount the partner recharges to issue an access card. The price for the issuance of an access card may refer to the amount consumed each time one access card is issued. The price for the issuance of an access card may vary depending on the type of the access card and the number of access cards issued. The current balance may refer to the amount obtained by subtracting an amount obtained by multiplying the price for the issuance of an access card by the number of access cards issued, from the recharge amount.

An access card list refers to a list of access cards created by the partner terminal 101. The access card list may provide a menu for viewing or editing classification of the access cards, a valid period, the number of creations, the number of issuances, and details of the access card.

Each item shown in FIG. 7 is merely an example, and items related to the access card may be further added.

FIG. 8 is a diagram illustrating a card creation page accessed by a partner terminal according to one embodiment of the present disclosure.

FIG. 8 shows a card creation page provided by the access card creation server 102 or the access card management server 402. Hereinafter, an operation between the partner terminal 101 and the access card creation server 101 will be described, and the following descriptions may also be applied to an operation between the partner terminal 401 and the access card management server 402 in the same manner. The card creation page of FIG. 8 is a page accessible by the partner terminal 101, and may be set for each access card that the partner terminal 101 wishes to create. An interface for creating an access card is not limited to FIG. 8.

For example, card information input or registered by the partner terminal 101 to create an access card may be created based on at least one of pieces of information. The card information described below is an example, and the present disclosure is not limited thereto.
(1) Issuance subject information for an access card (e.g., a phone number of the user terminal 104, an application ID of the user terminal 104, personal identification information related to a user of the user terminal 104 (e.g., student number or employee number))
(2) Issuance number information for an access card (the issuance number information may be set when there is no issuance subject information for the user terminal 104)
(3) Application identification information of a business entity corresponding to the partner terminal 101 (e.g., identification information (ID) for an official account related to the business entity of the partner terminal 101 in a messenger application)
(4) Information on the access terminal 101
(5) Type of access card (e.g., a pass, student ID card, membership card, etc.)
(6) Valid period information of an access card
(7) Whether the access card is able to be retrieved, transferred, re-transferred, a condition for enabling transfer or re-transfer (e.g., includes at least one of a pre-process condition to enable transfer or re-transfer, a temporal condition, a regional condition, or a personal condition who to be transferred or re-transferred)
(8) Store where an access card may be used (e.g., in a case of a chain store, an access card may be used only at a specific chain store) or local area where an access card may be used
(7) Connection information on a third-party server connected to an access card (e.g., when borrowing a book with a student ID card which is an access card, to confirm a status of borrowed books of a user of the student ID card in association with a library server)
(8) Display information for an access card (e.g., including at least one of a name, image or color, hologram, logo, or text data registered by the partner terminal 101 for an access card)

The access card creation page may provide an interface to edit the front and back of an access card as if it is a physical card. Information input to the card creation page for the access card may be different depending on the type of the access card.

For example, information representing the user of the user terminal 104 (a name, photo, nickname, email address, affiliation, etc.) and a name of an access card may be displayed on the front of the access card. Detailed information that varies depending on the type of access card may be input into the back of the access card. When the access card is a pass, the back of an access card may include a place where a user enters with the access card, an issuance subject for an access card (a user of the user terminal 104), a valid period of the access card, and the like.

Also, detailed information on the access card may be additionally input. For example, a method of using the access card matters to be aware of when using the access card, settings of a menu to request reissuance of the access card and a menu to request return of the access card, and the like may be additionally input by the partner terminal 101.

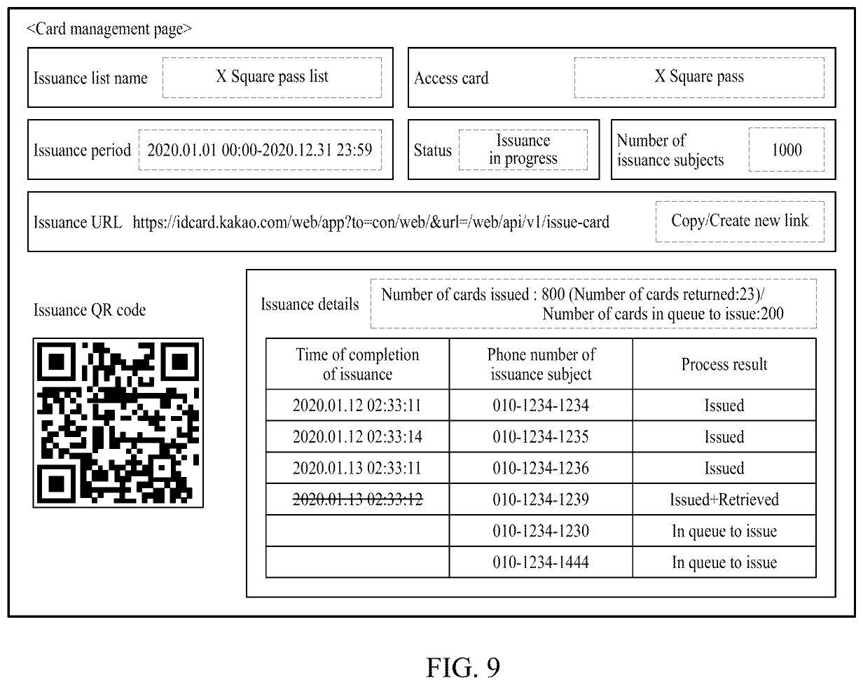

FIG. 9 is a diagram illustrating a card management page accessed by a partner terminal according to one embodiment of the present disclosure.

The card management page of FIG. 9 is a page accessible by the partner terminal 101, and may be set for each access card created by the partner terminal 101.

The card management page is a page for providing information on the issuance of the access card to the partner terminal 101 after the access card is created. The card management page may include an issuance period of the access card, an issuance link (a URL or a QR code), an issuance state of the access card, the number of issuance subjects of the access card, and issuance details of the access card.

When the issuance link is in the form of a URL, the partner terminal 101 may copy the issuance link and provide the copy to the user terminal 104 through an application. When the issuance link is a QR code, it may be provided to the partner terminal 101 so that the user terminal 104 may scan and recognize it.

When the partner terminal 101 creates N access cards, user information (e.g., a user account of an application or a phone number of the user terminal 104) may be assigned to the issuance details of the access card when the access card is issued. When an access card is not assigned to a specific user terminal and is issued on a first-come, first-served basis, user information included in the issuance details may be assigned when an access card is substantially issued to the user terminal 104 after the access card is created.

The state of the issuance and collection of the access card may be confirmed through the issuance details. The number of cases waiting for the issuance of an access card may refer to the number of cases excluding the number of issued cards from the number of issuance subjects.

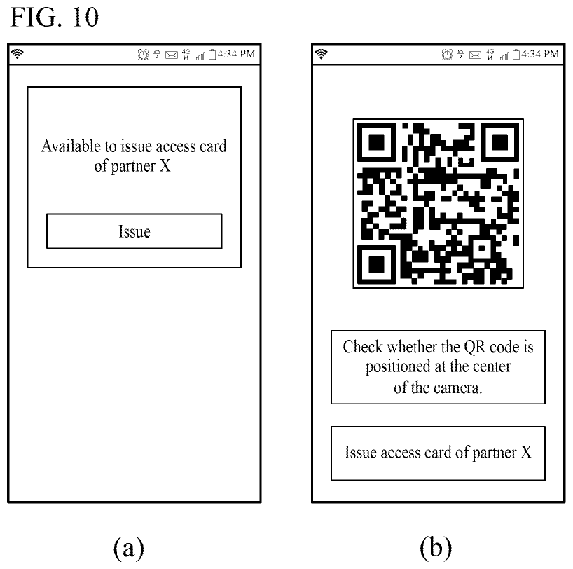

FIG. 10 is a diagram illustrating an example in which a user terminal accesses a card issuance page according to one embodiment of the present disclosure.

FIG. 10A shows a case where a link to a card issuance page of an access card, through which an access card may be issued, is transmitted through an application installed on the user terminal 104. For example, a link, through which an access card may be issued, may be provided to the user terminal 104 through a messenger application. In this case, the link may be provided through a chatroom in which a business entity corresponding to the partner terminal 101 participates or a chatroom in which a business entity corresponding to the access card creation server 102 participates. A chatroom in which a business entity participates may be expressed by a business entity's name or icon.

In addition, when a link to issue an access card through a chatroom is provided to the user terminal 104, the user terminal 104 may be linked to the access card to provide a link through the chatroom. For example, identification information (e.g., ID) of the application of the user terminal 104 and identification information (e.g., a phone number) for the user terminal 104 may be mapped to the access card.

When selecting an “Issue” menu in the user terminal 104, the user terminal 104 may transmit an issuance request for an access card by accessing the card issuance page through the link of the card issuance page connected to the menu.

FIG. 10B illustrates a case in which the user terminal 104 accesses a card issuance page by recognizing a QR code displayed on the partner terminal 101 or online (e.g., a website) or offline (e.g., a kiosk, a wall, and the like) through an application installed in the user terminal 104.

That is, referring to FIG. 10, the user terminal 104 may access the card issuance page provided by the access card issuance server 103 and request to issue an access card created by the partner terminal 101 by selecting a URL or recognizing a QR code through the application.

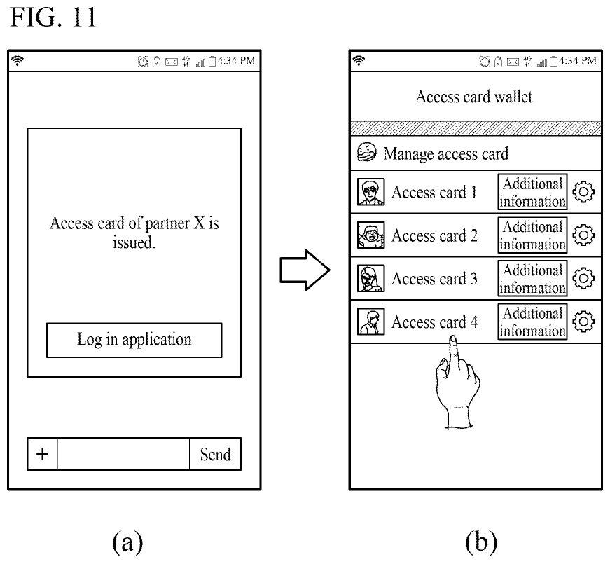

FIG. 11 is a diagram illustrating an example in which a user terminal issues an access card through an application according to one embodiment of the present disclosure.

Referring to FIG. 11A, when the access card created by the partner terminal 101 through the access card creation server 102 is generated, the user terminal 104 may request to issue the access card through the application. Also, when the access card is issued, a notification message related to the card issuance may be provided through the application.

For example, when the application is a messenger application, a message containing content that the access card is issued may be provided to the partner terminal 101 or the user terminal 104 in a chatroom related to the partner terminal 101 or the access card issuance server 103. In this case, the user terminal 104 may confirm the access card through the application. When data for the access card is provided to the user terminal 104 through the access card issuance server 104, the user terminal 104 may display the access card using the data for the access card through the application.

Referring to FIG. 11B, an interface in which access cards corresponding to the partner may be managed, for example, inquired, deleted, or edited may be provided in a particular function (e.g., an access card wallet) of the application installed on the user terminal 104. The user terminal 104 may receive a plurality of different types of access cards created by different partner terminals 101 through the application. In addition, the user terminal 104 may manage the plurality of different types of access cards created by the different partner terminals 101 through the interface shown in FIG. 11B. A list of access cards is provided through the application installed on the user terminal 104. Additional information may be assigned to each of the access cards.

For example, when an access card is generated in response to user information, additional information related to a condition for the access card to operate or for the access card to be valid may be additionally set. For example, the additional information may include time information, type information, profile information, verification information, and the like related to the access card.

The time information may refer to a start time point and an end time point for the access card to be valid. The type of information may refer to information indicating whether the access card is a one-time or semi-permanent card through reissuance, information indicating whether the access card may be shared/transferred to others, or information on a method of using the access card. The profile information may be related to personal information of a user to whom the access card is issued, such as region, age, gender, affiliation, or the like. The verification information may be related to qualifications that are essential for the user to engage in online or offline activities, such as whether the user has been vaccinated, has a license, or has signed up for a membership.

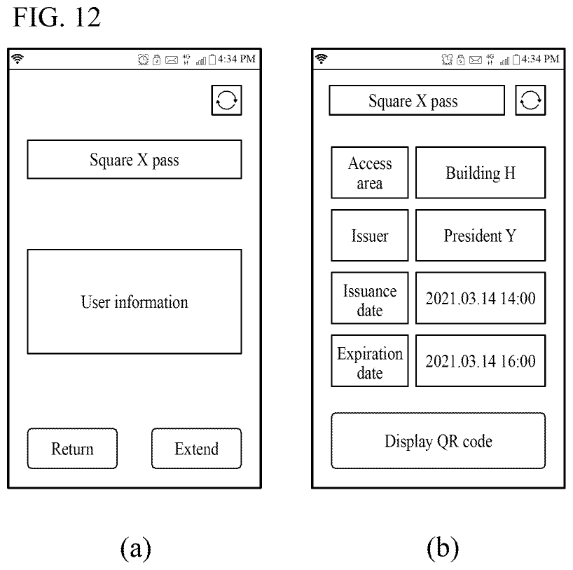

FIG. 12 is a diagram illustrating an example in which a user terminal manages an access card through an application according to one embodiment of the present disclosure.

FIGS. 12A and 12B show results of displaying the access card through the application of the user terminal 104. FIG. 12A may show the front of the access card described above with reference to FIG. 8, and FIG. 12B may correspond to the back of the access card described above with reference to FIG. 8.

Referring to FIG. 12A, user information and partner information of a partner related to the issuance of the access card may be provided in the application of the user terminal 104. In addition, a menu for returning and discarding the access card or extending a valid period may be provided through a display page. The user information may refer to information for identifying a user holding the user terminal 104, such as a user's name, user's photo, user's affiliation, user's nickname, user's email address, and the like.

Referring to FIG. 12B, pieces of information necessary for the use of the access card may be provided on the back of the access card. For example, as shown in FIG. 12B, a valid period of an access card (the date of issuance and the expiration date), a display menu of identification information corresponding to the access card (e.g., a QR code), detailed information on a partner generated the access card (e.g., an issuer), and location information to use the access card (e.g., an access area), and the like may be provided.

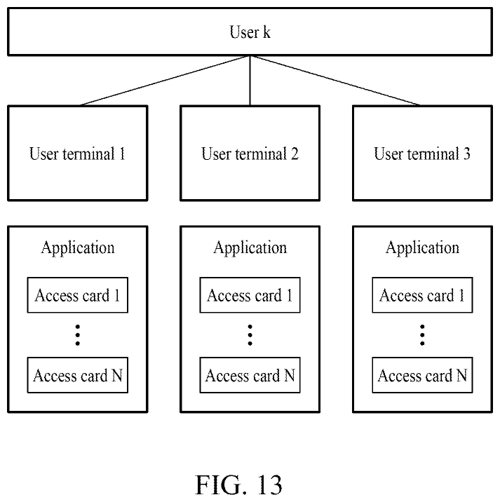

FIG. 13 is a diagram illustrating an example in which an access card is used through a plurality of user terminals according to one embodiment of the present disclosure.

Referring to FIG. 13, a method of providing an access card when a user possesses a plurality of user terminals is provided. In this case, the same application may be installed in the user terminals. In addition, a list of access cards may be provided through the application installed on each user terminal.

For example, in each of the user terminals possessed by the same user (e.g., a user k), the same user information (e.g., user account) may be set through the application. Then, the list of access cards displayed through the application installed on each of the user terminals may also be provided in the same manner.

In another example, in each of the user terminals possessed by the same user (e.g., the user k), the same user information (e.g., user account) may be set through the application. However, the list of access cards displayed through the application installed on each of the user terminals may be provided differently for each user terminal.

For example, the list of access cards may be provided differently based on the types of the user terminals (e.g., whether it is a smartphone, a tablet personal computer (PC), or a wearable device), frequency of use of the user terminals, priority set for the user terminals, and attributes of the user terminals (a screen size, communication support method, etc.) set by a partner that generated the access cards.

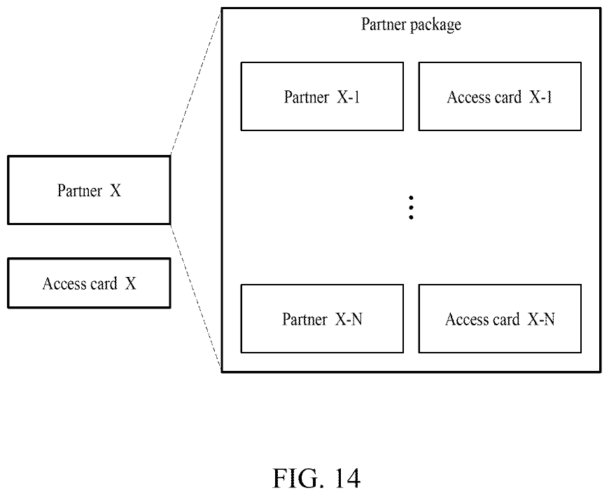

FIG. 14 is a diagram illustrating an example of generating an access card corresponding to a partner package according to one embodiment of the present disclosure.

The partner terminal 101 that creates the access card may be associated with a partner X. At this time, when the partner X includes partners X-1 to X-N on a lower level, the partner terminal 101 may create access cards in the unit of a package of the partners for the partner X.

For example, in a case where the partner X corresponds to a particular university and the partners X-1 to X-N correspond to colleges located in the particular university, when creating an access card (e.g., a pass) of the partner X on the user terminal 104, the partner terminal 101 may also create access cards of the partners X-1 to X-N belonging to the lower level of the partner X.

In this case, to the application installed on the user terminal 104, only information on the access card of the partner X on a higher level may be provided, or information on the access card of the partner X and the access cards of the partners X-1 to X-N belonging to the lower level of the partner X may be provided together.

In a case where the partners are structured hierarchically, when an access card of a partner on a higher level is created, access cards of partners on a lower level may be automatically generated in the unit of a partner package. In this case, a hierarchical relationship for the partners may be input on the partner terminal 101. In addition, the access cards corresponding to the partners on the lower level may be created independently of the access cards corresponding to the partner on the higher level. For example, as shown in FIG. 8, in the card creation page, information input when creating the access card corresponding to the partner on the higher level may be set differently from information input when creating the access cards corresponding to the partners on the lower level.

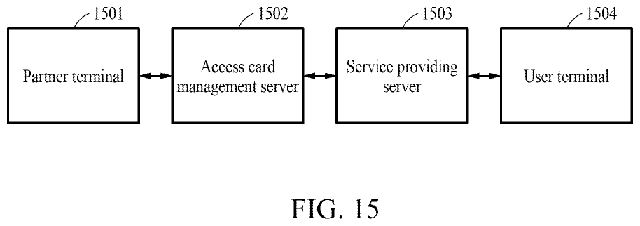

FIG. 15 is a diagram illustrating an apparatus for performing a service providing method using an access card and a service filtering method according to one embodiment of the present disclosure.

FIG. 15 illustrates a partner terminal 1501, an access card management server 1502, a service providing server 1503, and a user terminal 1504.

Hereinafter, a service providing method according to one embodiment of the present disclosure is described. The partner terminal 1501 may create an access card through the access card management server 1502. In this case, the partner terminal 1501 may subscribe to a service for creating an access card through an account. In addition, the partner terminal 1501 may subscribe to an application service provided by the service providing server 1503 with an account that is the same as or different from the account used when subscribing to the service for creating an access card.

For example, the application service may be a service (e.g., a TV service, a radio service, and a search service) performed by the user terminal 1504 through an access card. The application services may include a service provided through an app or a service provided through the web.

The user terminal 1504 may be issued and retain an access card through the access card management server 1502. That the user terminal 1504 retains an access card may indicate that (i) the user terminal 1504 downloads an access card from the access card management server 1502 and stores the access card in a storage area of the user terminal 1504, or (ii) the access card management server 1502 stores the access card as a retaining card of a user account corresponding to the user terminal 1504.

The application server 105 of FIG. 1 may relate to an application in association with creation and issuance of an access card and the service providing server 1503 of FIG. 15 may provide an application service provided to the user terminal 1504 through an access card.

The partner terminal 1501 that requests for an account to create an access card may set a filtering condition to an application service provided by the service providing server 1503 with the account. That is, a filtering condition related to an access card may be set to an application by an account of the partner terminal. For this, the service providing server 1503 may request for a list of access cards, to which the account of the partner terminal 1501 has permission, to the access card management server 1502. In addition, the access card management server 1502 may transmit the list of access cards with accounts granted with permissions to the service providing server 1503. In this case, the permission may be a permission to be provided with content through an application service or a detailed function of an application service.

When the user terminal 1504 transmits a provision request for the application service to the service providing server 1503, the service providing server 1503 may compare a filtering condition set to the application service requested by the user terminal 1504 with an access card issued to the user terminal 1504. That is, when the user terminal 1504 is issued and retains an access card satisfying the filtering condition set to the application service, the user terminal 1504 may use the application service provided by the service providing server 1503.

The filtering condition may be set to an application to be used by the user terminal 1504 by the account of the partner terminal 1501. For example, whether the filtering condition set to the application service is satisfied may be determined by a type, the number of access cards issued to the user terminal 1504, or a combination of the access cards. When the access card issued to the user terminal 1504 satisfies the filtering condition set to the application service by the account of the partner terminal 1501, the user terminal 1504 may use the application service.

In this case, the filtering condition set to the application service may be set by a retaining status or method of the access card. For example, the filtering condition may include a condition in which the user terminal 1504 is issued and retains at least one of a plurality of access cards set to the application service (a union). In addition, the filtering condition may include a condition in which the user terminal 1504 is issued and retains all of the plurality of access cards set to the application service (an intersection). In addition, the filtering condition may include a condition in which all of the plurality of access cards set to the application service are not issued (a complement set).

That is, according to one embodiment of the present disclosure, an access card created with an account of the partner terminal 1501 may be set to be a filtering condition of an application service, and an application service meeting an intention of the partner terminal 1501 may be provided by determining whether to provide the application service based on whether an access card issued to the user terminal 1504 satisfies the filtering condition.

Hereinafter, a service filtering method according to one embodiment of the present disclosure is described.

The partner terminal 1501 may create an access card through a creation page of the access card provided by the access card management server 1502. The access card may be a virtual card including information on qualifications to log in and access a specific online area (e.g., a website or an application) related to a partner.

According to one embodiment of the present disclosure, the user terminal 1504 may use a service function of an application service provided by the service providing server 1503. The application services may include a service provided through an app or a service provided through the web. For example, the application service may be a service (e.g., a TV service, a radio service, and a search service) performed by the user terminal 1504 through an access card as the user terminal 1504 logs in with a specific account.

The application server 105 of FIG. 1 may relate to an application in association with creation and issuance of an access card and the service providing server 1503 of FIG. 15 may provide an application service provided to the user terminal 1504 through an access card.

In this case, the service function may be differently provided based on retention of an access card issued to the user terminal 1504 through the access card management server 1502 and a type of the access card. The partner terminal 1501 may set a filtering condition to provide a function of a specific service of the application service to the user terminal 1504 that is issued and retains a specific access card.

According to one embodiment of the present disclosure, the user terminal 1504 may use content through an application service provided by the service providing server 1503. In this case, the content may be differently provided based on retention of an access card issued to the user terminal 1504 through the access card management server 1502 and a type of the access card. The partner terminal 1501 may set a filtering condition to the user terminal 1504 that is issued and retains a specific access card to provide content of an application service.

The partner terminal 1501 that creates the access card may set a filtering condition for a service function of the application service to provide a specific service function (e.g., restricting a conversation in a chatbot, providing a target message, and entering a chatroom) of the application service to the user terminal 1504 retaining a specific access card.

Then, as the user terminal 1504 retaining an access card satisfying the filtering condition retains the specific access card, the service providing server 1503 may proceed with a process of determining whether a specific service function of the application service is enabled or disabled.

When a video live streamed or uploaded by the partner terminal 1501 that creates the access card is provided and the user terminal 1504 retaining an access card satisfying a filtering condition assigned to content or a specific service function of the application service requests to watch the video, a right or qualification to watch the video may be automatically determined through the service providing server 1503.

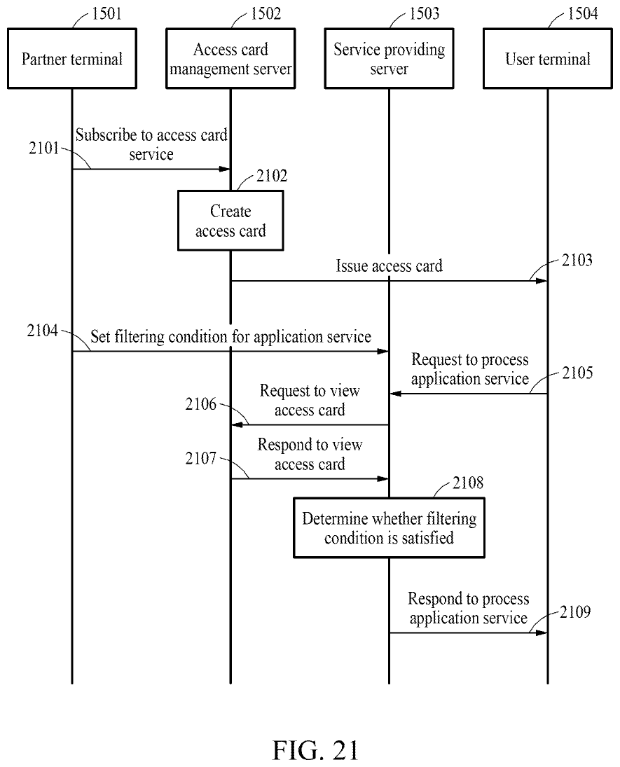

A detailed description of a service filtering method according to one embodiment of the present disclosure is provided with reference to FIGS. 21 to 26.

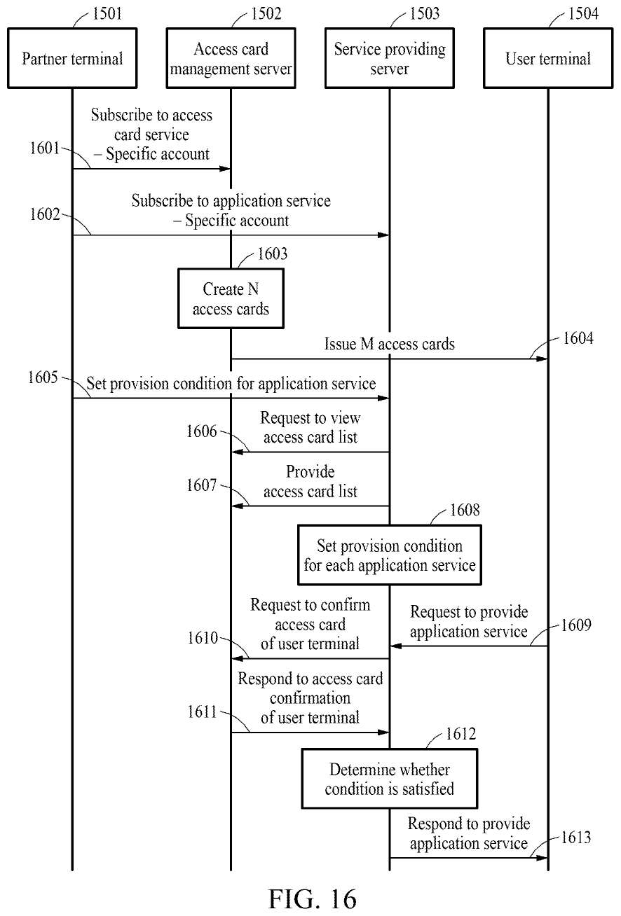

FIG. 16 is a flowchart of a service providing method using an access card according to one embodiment of the present disclosure.

In operation 1601, the partner terminal 1501 may subscribe to an access card creation service of the access card management server 1502. In this case, the partner terminal 1501 may subscribe with an account (e.g., an email address and an ID) to the card creation service.

In operation 1602, the partner terminal 1501 may subscribe to an application service provided by the service providing server 1503. That is, the partner terminal 1501 may subscribe to the application service provided by the service providing server 1503 with an account that is the same as or different from the account used when subscribing to the access card creation service.

In operation 1603, the access card management server 1502 may create N access cards (N is greater than or equal to 1) corresponding to the account of the partner terminal 1501. In this case, the N access cards may be the same type of access cards or different types of access cards. The process of creating the access card is shown with reference to the descriptions of FIGS. 1 to 6.

In operation 1604, the access card management server 1502 may issue M access cards to the user terminal 1504 based on a setting of the partner terminal 1501. In this case, M may be less than or equal to N. The user terminal 1504 may be issued and retain the access card. For example, that the user terminal 1504 retains the access card may refer to downloading the access card from the access card management server 1502 and storing the access card in a storage area of the user terminal 1504. Alternatively, that the user terminal 1504 retains the access card may refer to the access card management server 1502 storing the access card as a retaining card of a user account corresponding to the user terminal 1504.

In operation 1605, the partner terminal 1501 may set a filtering condition to each of application services with an account. The filtering condition may be a provision condition to provide an application service requested by the user terminal 1504. The filtering condition may include at least one of a setting of an access card and retention of an access card for each application service. Through the retention of the access card to which a permission is granted by an account of the partner terminal 1501, the user terminal 1504 may use the application service.

Although FIG. 16 illustrates one service providing server 1503, when one or more application services are connected to an account, one or more service providing servers 1503 providing the one or more application services may exist. In addition, the one or more service providing servers 1503 respectively corresponding to the one or more application services may operate the same as the service providing server of FIG. 16.

In operation 1606, the service providing server 1503 may transmit a view request of a list of access cards, to which the account of the partner terminal 1501 has permission, to the access card management server 1502. In this case, the permission to use the application service may be set by the account of the partner terminal 1501. In addition, the user terminal 1504 retaining the access card satisfying the filtering condition set by the account of the partner terminal 1501 may use the application service.

In operation 1607, the access card management server 1502 may provide a list of access cards to which permission is granted by the account to the service providing server 1503 in response to the view request of the service providing server 1503. The list of access cards may include information on the same type or different types of M access cards (M is a natural number greater than 1) issued to the user terminal 1504.

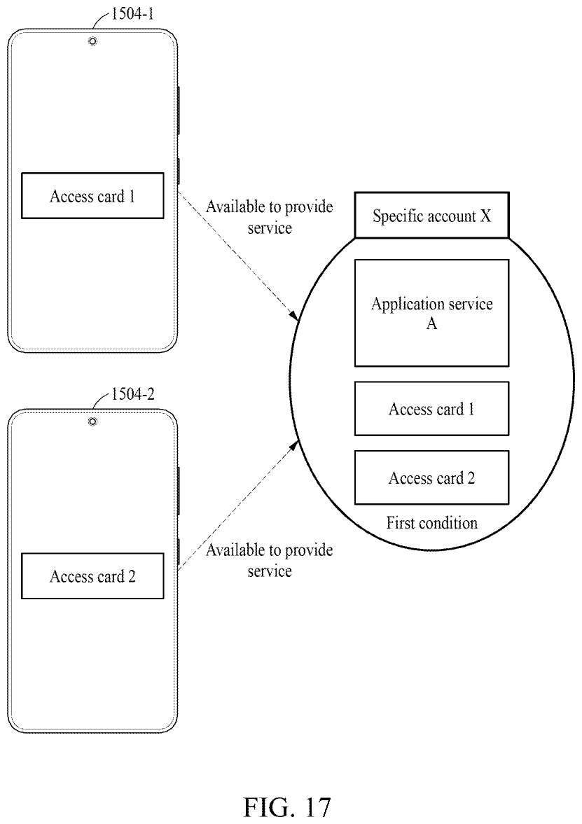

In operation 1608, the service providing server 1503 may set a filtering condition to the application service requested by the account of the partner terminal 1501. The filtering condition is described with reference to FIGS. 17 to 19. The service providing server 1503 may transmit a notification that the filtering condition requested by the account of the partner terminal 1501 is set to the application service to the partner terminal 1501 through a message.

In operation 1609, the user terminal 1504 may transmit a provision request of the application service to the service providing server 1503.

In operation 1610, the service providing server 1503 may transmit, to the access card management server 1502, a confirmation request of an access card issued to the user terminal 1504 in response to the provision request of the user terminal 1504.

In operation 1611, the access card management server 1502 may transmit, to the service providing server 1503, a confirmation request corresponding to the confirmation request of the access card issued to the user terminal 1504. The confirmation request may include information on access cards issued to the user terminal 1504.

In operation 1612, the service providing server 1503 may determine whether the access card issued to the user terminal 1504 satisfies a filtering condition set to the application service that the user terminal 1504 desires to use.

In operation 1613, the service providing server 1503 may provide the application service to the user terminal 1504 or a message that the application service is not available to the user terminal 1504 based on whether the access card issued to the user terminal 1504 satisfies the filtering condition set to the application service.

FIG. 17 is a diagram illustrating a process of determining whether a service is provided based on a first condition set to an application service and an access card issued to a user terminal according to one embodiment of the present disclosure.

Referring to FIG. 17, an application service A subscribed with an account X of the partner terminal 1501 may exist. As described above, one or more application services may be connected to an account of the partner terminal 1501 and the user terminal 1504 may be provided with the application service based on an access card. Whether to provide the application service may be determined based on a filtering condition determined by retention and manner of an access card to which the account of the partner terminal 1501 has permission.

In addition, it may be assumed that the partner terminal 1501 sets a first condition for access cards 1 and 2 to the application service A. The first condition may be a condition indicating that when the user terminal 1504 retains at least one of access cards set to an application service (a union), the user terminal 1504 is qualified to be provided with the application service.

As shown in FIG. 17, the first condition may be a condition indicating that when the user terminal 1504 is issued and retains at least one of the access cards 1 and 2, the user terminal 1504 is qualified to be provided with the application service A. Therefore, when the user terminal 1504 is issued the access card 1, or the access card 2, or both of the access cards 1 and 2, it may be determined that the user terminal 1504 satisfies the first condition for the application service A.

Then, since a user terminal 1504-1 is issued and retains the access card 1, the user terminal 1504-1 may satisfy the first condition for the application service A. It may be determined that the user terminal 1504-1 is qualified to use the application service A.

In addition, since a user terminal 1504-2 is issued and retains the access card 2, the user terminal 1504-2 may satisfy the first condition for the application service A. Therefore, it may be determined that the user terminal 1504-2 is also qualified to use the application service A.

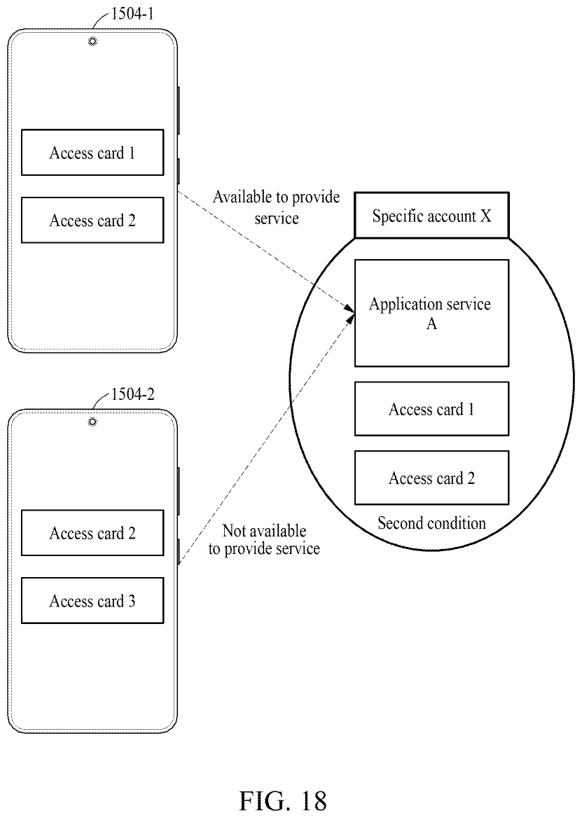

FIG. 18 is a diagram illustrating a process of determining whether a service is provided based on a second condition set to an application service and an access card issued to a user terminal according to one embodiment of the present disclosure.

Referring to FIG. 18, an application service A subscribed with an account X may exist. As described above, one or more application services may be connected to an account and the user terminal 1504 may be provided with the application service based on an access card.

In addition, it may be assumed that the partner terminal 1501 sets a second condition for access cards 1 and 2 to the application service A. The second condition may be a condition indicating that when the user terminal 1504 retains all access cards set to an application service (an intersection), the user terminal 1504 is qualified to be provided with the application service.

As shown in FIG. 18, the second condition may be a condition indicating that when the user terminal 1504 is issued and retains both of the access cards 1 and 2, the user terminal 1504 is qualified to be provided with the application service A. Therefore, when the user terminal 1504 is issued both of the access cards 1 and 2, it may be determined that the user terminal 1504 satisfies the second condition for the application service A.

Then, since the user terminal 1504-1 is issued and retains both of the access cards 1 and 2, the user terminal 1504-1 may satisfy the second condition for the application service A. It may be determined that the user terminal 1504-1 is qualified to use the application service A.

However, since the user terminal 1504-2 is not issued and does not retain the access card 2 and an access card 3, the user terminal 1504-2 may not satisfy the second condition for the application service A. Therefore, it may be determined that the user terminal 1504-2 is not qualified to use the application service A, and the service providing server 1503 may transmit a message related to the unavailability of the application service A to the user terminal 1504-2.

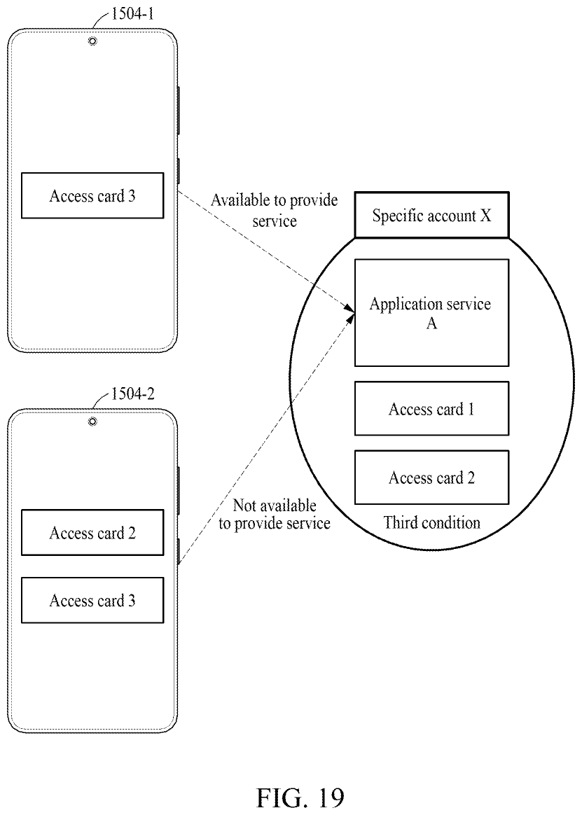

FIG. 19 is a diagram illustrating a process of determining whether a service is provided based on a third condition set to an application service and an access card issued to a user terminal according to one embodiment of the present disclosure.

Referring to FIG. 19, an application service A subscribed with an account X may exist. As described above, one or more application services may be connected to an account and the user terminal 1504 may be provided with the application service based on an access card.

In addition, it may be assumed that the partner terminal 1501 sets a third condition for access cards 1 and 2 to the application service A. The third condition may be a condition indicating that when the user terminal 1504 does not retain all access cards set to an application service (a complement set), the user terminal 1504 is qualified to be provided with the application service.

As shown in FIG. 19, the third condition may be a condition indicating that when the user terminal 1504 is not issued both of the access cards 1 and 2, the user terminal 1504 is qualified to be provided with the application service A. Therefore, when the user terminal 1504 is issued the access card 1, or the access card 2, or both of the access cards 1 and 2, it may be determined that the user terminal 1504 does not satisfy the third condition for the application service A.

Then, since the user terminal 1504-1 is issued and retains an access card 3, the user terminal 1504-1 may satisfy the third condition for the application service A. The user terminal 1504-1 may use the application service A.

In addition, since the user terminal 1504-2 is issued and retains the access cards 2 and 3, the user terminal 1504-2 does not satisfy the third condition for the application service A. Therefore, the user terminal 1504-2 may not use the application service A and the service providing server 1503 may transmit a message related to the unavailability of the application service A to the user terminal 1504-2.

Although not described with reference to FIGS. 17 to 19, the access card 1 may be set to the application service A and a condition may be set that the user terminal 1504 retaining only the access card 1 is allowed to use the application service A.

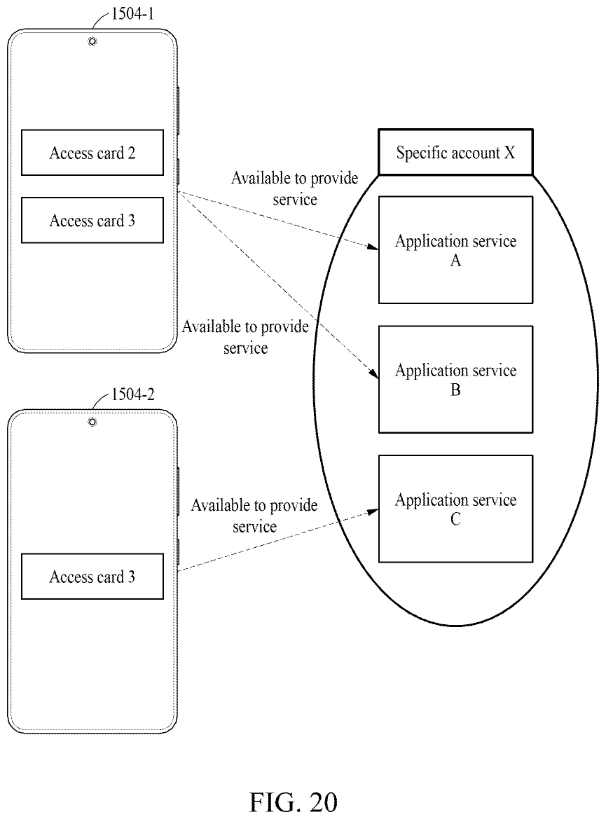

FIG. 20 is a diagram illustrating an example of differently setting conditions to a plurality of application services, according to one embodiment of the present disclosure

Referring to FIG. 20, it may be assumed that access cards 1 to 3 are created for an account X that is registered when the partner terminal 1501 subscribes to a creation service of an access card. In addition, application services A to C are subscribed with the account X that is registered when the partner terminal 1501 subscribes to the creation service of the access card.

In this case, different conditions may be respectively set to the application services A to C. In this case, the condition may include the conditions described with reference to FIGS. 17 to 19, the present disclosure is not limited thereto.

For example, the user terminal 1504-1 may use the application service A when a condition in which any one of the access cards 2 and 3 is issued, or a condition in which both of the access cards 2 and 3 are issued, or a condition in which the access card 1 is not issued, is set to the application service A.

In addition, the user terminal 1504-2 may use the application service C when a condition for the access card 1 and a condition in which any one of the access cards 2 and 3 is issued are set to the application service C.

Although a condition set to an application service is described in the unit of an application service in FIGS. 17 to 20, the condition may be set to a detailed function unit of an application service. For example, when detailed functions a-1, a-2, and a-3 are provided in the application service A and the user terminal 1504 retains only the access card 1, the user terminal 1504 may use the detailed function a-1. When the user terminal 1504 retains at least one of the access cards 2 and 3, the user terminal 1504 may use the detailed function a-2 and only when the user terminal 1504 does not retain the access card 3, the user terminal 1504 may use the detailed function a-3. As described above, a use condition of the user terminal 1504 may vary depending on the detailed function of the application service.

The application service described with reference to FIGS. 17 to 20 may include a messaging service through instant messaging. In addition, a filtering condition may be set to each detailed function of the application service. In this case, when the application service is a messaging service, the detailed function may include at least one of (i) a function to enter a chatroom of the messaging service, (ii) a function to use a chatbot in a chatroom of the messaging service, (iii) a function to highlight a chat message in a chatroom, (iv) a function to post an announcement in a chatroom, (v) a function to search or share a search result in a chatroom, (vi) a function to share content (e.g., an image, a video, and a link) in a chatroom, and (vii) a function to use an additional service accessible through the messaging service.

For example, the application service may include a video service. In addition, when the application service is a video service, the detailed function may include at least one of (i) a function to skip an advertisement inserted in the middle of a video, (ii) a function to share a video, (iii) a function to watch a video (e.g., adult authentication, age or regional restriction), and (iv) a function to download or edit a video.

For example, the application service may include a social network service. In addition, when the application service is a social network service, the detailed function may include at least one of (i) a function to add a friend, (ii) a function to upload or download content, and (iii) a function to chat with a friend.

FIG. 21 is a flowchart illustrating a service filtering method according to one embodiment of the present disclosure.

In operation 2101, the partner terminal 1501 may subscribe to an access card creation service in the access card management server 1502.

In operation 2102, the access card management server 1502 may create an access card based on card information on an access card input by the partner terminal 1501.

In operation 2103, the access card management server 1502 may issue the access card created by the partner terminal 1501 to the user terminal 1504.

In operation 2104, the partner terminal 1501 may set a filtering condition for an application service provided by the service providing server 1503.

In operation 2105, the user terminal 1504 may transmit a process request for the application service to the service providing server 1503.

In operation 2106, the service providing server 1503 may transmit, to the access card management server 1502, a view request of an access card issued to the user terminal 1504.

In operation 2107, the access card management server 1502 may transmit, to the service providing server 1503, a view response including information on an access card including whether the user terminal 1504 retains an issued access card and a type of the access card.

In operation 2108, the service providing server 1503 may determine whether the access card issued to the user terminal 1504 satisfies the filtering condition for the application service based on the information on the access card issued to the user terminal 1504.

In operation 2109, the service providing server 1503 may transmit, to the user terminal 1504, a process response for the application service based on whether the filtering condition for the application service is satisfied.

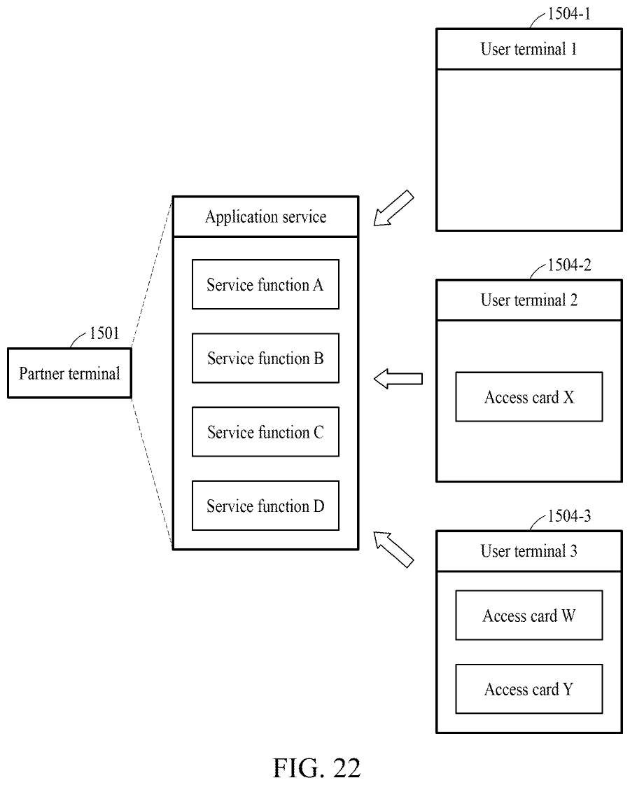

FIG. 22 is a diagram illustrating a service filtering method related to a service function of an application service according to one embodiment of the present disclosure.

Referring to FIG. 22, the partner terminal 1501 may subscribe to an application service and may provide the application service to the user terminals 1504-1 to 1504-3. In this case, the partner terminal 1501 may set a filtering condition to each of a plurality of service functions (e.g., service functions A to D) that may be implemented in the application service.

In this case, the filtering condition may be a condition to determine whether to provide a service function when the user terminals 1504-1 to 1504-3 request a specific service function of the application service. For example, whether to provide a service function may be determined based on whether a filtering condition is satisfied wherein the filtering condition is set based on at least one of whether the access card issued to the user terminals 1504-1 to 1504-3 retains an access card created by the partner terminal 1501, a combination of access cards, permission set to an access card, the number of access cards, and a type of an access card.

Referring to FIG. 22, it may be assumed that the user terminals 1504-1 to 1504-3 request to use a service function B of an application service. Then, the service providing server 1503 may check a filtering condition set to a service function of the application service. In addition, the service providing server 1503 may determine whether the user terminals 1504-1 to 1504-3 retain an access card satisfying the filtering condition. When the user terminals 1504-1 to 1504-3 retain an access card satisfying the filtering condition, the service providing server 1503 may provide a service function of the application service to the user terminals 1504-1 to 1504-3.

For example, it may be assumed that the application service is a chat service and the service function B is a function to post an announcement in a chatroom. In addition, the filtering condition set to the service function B of the application service may be whether an access card is retained. Then, since the user terminal 1 1504-1 is not issued and does not retain the access card, the user terminal 1 1504-1 may not perform the service function B. In addition, the user terminal 2 1504-2 and the user terminal 3 1504-3 may be provided with the service function B.

For example, it may be assumed that the application service is a chat service and the service function C is a function to highlight a chat message in a chatroom. In addition, the filtering condition set to the service function C of the application service may be whether an access card Y is retained. Then, since the user terminal 1 1504-1 and the user terminal 2 1504-2 do not retain the access card Y, the user terminal 1 1504-1 and the user terminal 2 1504-2 may not perform the service function C and only the user terminal 3 1504-3 may be provided with the service function C.

For example, it may be assumed that the application service is a chat service and the service function D is a function to perform a chatbot function in a chatroom. In addition, the filtering condition set to the service function D of the application service may be whether 3 or more access cards are retained. Then, since all of the user terminal 1 1504-1, the user terminal 2 1504-2 and the user terminal 3 1504-3 do not retain 3 or more access cards, the user terminal 1 1504-1, the user terminal 2 1504-2, and the user terminal 3 1504-3 may not be provided with the service function D.

The description provided above indicates a case in which the user terminals 1504-1 to 1504-3 request to use a service function of an application service. On the other hand, among the user terminals 1504-1 to 1504-3 issued an access card created by the partner terminal 1501, the service providing server 1503 may recommend to or notify the user terminals 1504-1 to 1504-3 satisfying the filtering conditions of the service functions A to D of the availability of service function of the application service.

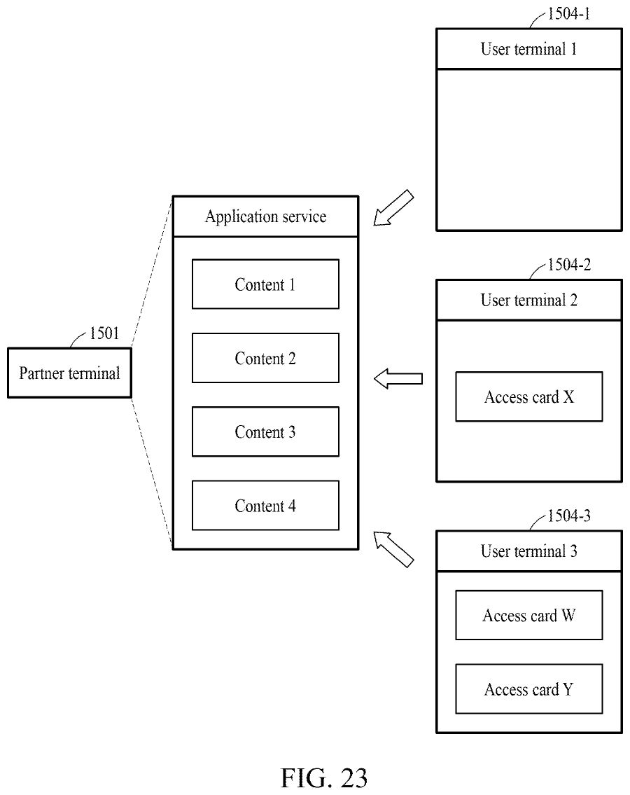

FIG. 23 is a diagram illustrating a service filtering method related to content provided by an application service according to one embodiment of the present disclosure.

Referring to FIG. 23, unlike FIG. 22, a case in which content is provided to the user terminals 1504-1 to 1504-3 through an application service is described. The partner terminal 1501 may post a plurality of contents (e.g., contents 1 to 4) by uploading or posting the plurality of contents through an application service.

In this case, filtering conditions related to a use condition of each content may be respectively set to the plurality of contents (the contents 1 to 4) by the partner terminal 1501. In this case, the filtering condition may be a condition to determine whether to provide content when the user terminals 1504-1 to 1504-3 request to use the content posted through the application service. For example, whether to provide the content may be determined based on whether a filtering condition is satisfied wherein the filtering condition is set based on at least one of whether an access card issued by the user terminals 1504-1 to 1504-3 retains an access card created by the partner terminal 1501, a combination of access cards, permission set to an access card, the number of access cards, and a type of an access card.

Referring to FIG. 23, it may be assumed that the user terminals 1504-1 to 1504-3 request to use content of an application service. Then, the service providing server 1503 may check the filtering condition set to the content of the application service. In addition, the service providing server 1503 may determine whether the user terminals 1504-1 to 1504-3 retain an access card satisfying the filtering condition set to the content. When the user terminals 1504-1 to 1504-3 retain an access card satisfying the filtering condition, the service providing server 1503 may provide the content posted through the application service to the user terminals 1504-1 to 1504-3.

For example, it may be assumed that the application service is a video service and the content A is content only allowed to an adult over the age of 19. In addition, the filtering condition for the content A of the application service may be whether an access card is retained. Then, since the user terminal 1 1504-1 is not issued and does not retain the access card, the user terminal 1 1504-1 may not watch the content A and the user terminal 2 1504-2 and the user terminal 3 1504-3 may watch the content A.

For example, it may be assumed that the application service is a blog service and the content B may be allowed only to a member registered as a friend on the blog. In addition, the filtering condition set to the content B posted on the application service may be whether the access card Y is retained. Then, since the user terminal 1 1504-1 and the user terminal 2 1504-2 do not retain the access card Y, only the user terminal 3 1504-3 may check the content B.

For example, it may be assumed that the application service is a messaging service and the content D is a file uploaded in a chatroom. In addition, the filtering condition set to the content D in the application service may be whether 3 or more access cards are retained. Then, since all of the user terminal 1 1504-1, the user terminal 2 1504-2 and the user terminal 3 1504-3 do not retain 3 or more access cards, the user terminal 1 1504-1, the user terminal 2 1504-2, and the user terminal 3 1504-3 may not be allowed to download the content D.

The description provided above indicates a case in which the user terminals 1504-1 to 1504-3 request to use content through an application service. On the other hand, among the user terminals 1504-1 to 1504-3 issued an access card created by the partner terminal 1501, the service providing server 1503 may recommend to or notify the user terminals 1504-1 to 1504-3 satisfying the filtering conditions respectively set to the contents of the application service of the availability of the contents of the application service.

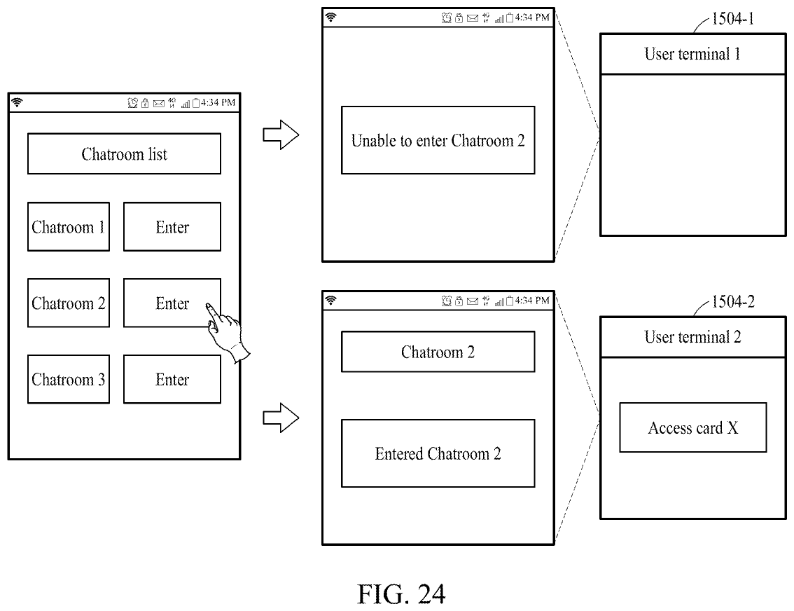

FIG. 24 is a diagram illustrating an example in which, when an application service is a chat service, an entry status to a chatroom varies depending on an issuance of an access card to a user terminal, according to one embodiment of the present disclosure.

FIG. 24 may assume that the application service is a chat service and entering a chatroom is a service function of the application service. In addition, the filtering condition for the service function may be retention of an access card. In the present disclosure, the filtering condition may be differently determined based on at least one of retention of an access card, a combination of access cards, permission set to an access card, the number of access cards, and a type of an access card.

In this case, since the user terminal 1 1504-1 does not retain an access card, even if the user terminal 1 1504-1 requests for a chatroom 2 to enter, the user terminal 1 1504-1 may receive a message that the user terminal 1 1504-1 is not able to enter the chatroom 2. On the other hand, since the user terminal 2 1504-2 retains an access card, when the user terminal 1 1504-1 requests for the chatroom 2 to enter, the user terminal 2 1504-2 may receive a message that the user terminal 1 1504-1 enters the chatroom 2.

Based on an assumption that retention of an access card Y is a filtering condition for a service function to enter a chatroom, not only the user terminal 1 1504-1 that does not retain the access card Y but also the user terminal 2 1504-2 may not enter the chatroom.

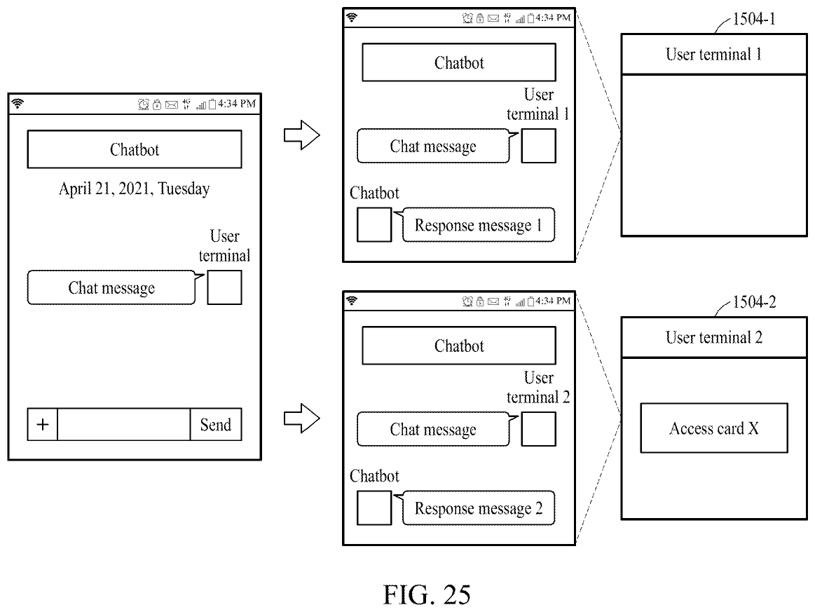

FIG. 25 is a diagram illustrating an example in which, when an application service is a chatbot service, a response message varies depending on an issuance of an access card to a user terminal, according to one embodiment of the present disclosure.

Referring to FIG. 25, it may be assumed that the application service is a chatbot service of a chat service and the service function is receiving a response message. For example, it may assume a case in which different response messages are received based on whether an access card is retained.

It may be assumed that the user terminal 1504-1 does not retain an access card and the user terminal 1504-2 retains the access card. In this case, when entering a chat message to a chatbot, a response message thereto may be differently provided based on whether the access card is retained. The user terminal 1504-1 may receive a response message 1 to the chat message and the user terminal 1504-2 may receive a response message 2 that is different from the response message 1 to the same chat message.

For example, when entering a chat message to the chatbot, a response message thereto may be differently provided based on whether an access card X is retained (a type of an access card). The user terminal 1504-1 may receive a response message 1 to the chat message and the user terminal 1504-2 may receive a response message 2 that is different from the response message 1 to the same chat message.

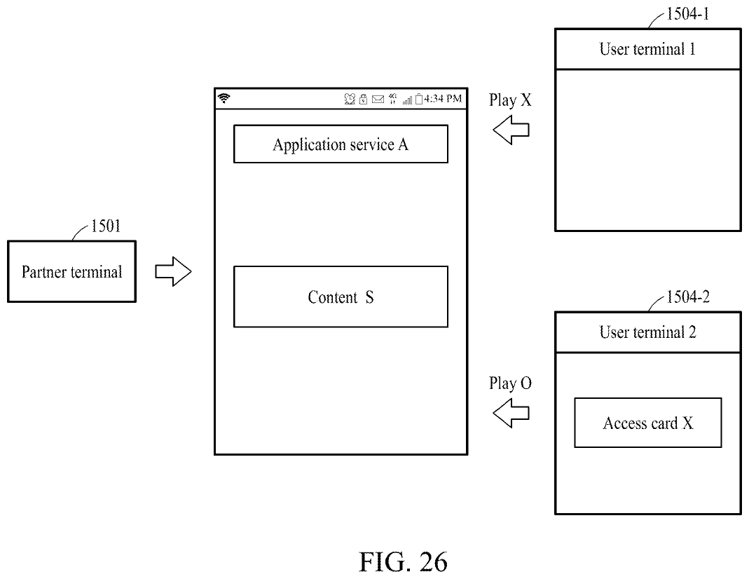

FIG. 26 is a diagram illustrating an example in which an access status to content provided by an application service varies depending on an issuance of an access card to a user terminal, according to one embodiment of the present disclosure.

Referring to FIG. 26, a filtering condition for content provided through an application service may be set. In this case, the filtering condition may be whether the user terminal 1504-1 or 1504-2 retains an access card created by the partner terminal 1501. It may be assumed that when the partner terminal 1501 posts content S on an application service A, the user terminals 1504-1 and 1504-2 request to play the content S.

In this case, when the filtering condition set to the content S is retention of an access card, the user terminal 1 1504-1 that does not retain the access card may not be provided with a playback result of the content S. On the other hand, the user terminal 2 1504-2 retaining the access card may be provided with the playback result of the content S.

Unlike the example of FIG. 26, when the filtering condition for the content S is retention of a plurality of access cards or retention of the access card Y, both of the user terminal 1 1504-2 and the user terminal 2 1504-2 may not be provided with the playback result of the content S.

The method according to example embodiments may be written in a computer-executable program and may be implemented as various recording media such as magnetic storage media, optical reading media, or digital storage media.

Various techniques described herein may be implemented in digital electronic circuitry, computer hardware, firmware, software, or combinations thereof. The implementations may be achieved as a computer program product, for example, a computer program tangibly embodied in a machine readable storage device (a computer-readable medium) to process the operations of a data processing device, for example, a programmable processor, a computer, or a plurality of computers or to control the operations. A computer program, such as the computer program(s) described above, may be written in any form of a programming language, including compiled or interpreted languages, and may be deployed in any form, including as a stand-alone program or as a module, a component, a subroutine, or other units suitable for use in a computing environment. A computer program may be deployed to be processed on one computer or multiple computers at one site or distributed across multiple sites and interconnected by a communication network.

Processors suitable for processing of a computer program include, by way of example, both general and special purpose microprocessors, and any one or more processors of any kind of digital computer. Generally, a processor will receive instructions and data from a read-only memory or a random-access memory, or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Examples of information carriers suitable for embodying computer program instructions and data include semiconductor memory devices, e.g., magnetic media such as hard disks, floppy disks, and magnetic tape, optical media such as compact disk read only memory (CD-ROM) or digital video disks (DVDs), magneto-optical media such as floptical disks, read-only memory (ROM), random-access memory (RAM), flash memory, erasable programmable ROM (EPROM), or electrically erasable programmable ROM (EEPROM). The processor and the memory may be supplemented by, or incorporated in special purpose logic circuitry.

In addition, non-transitory computer-readable media may be any available media that may be accessed by a computer and may include both computer storage media and transmission media.

Although the present specification includes details of a plurality of specific example embodiments, the details should not be construed as limiting any disclosure or a scope that can be claimed, but rather should be construed as being descriptions of features that may be peculiar to specific example embodiments of specific disclosures. Specific features described in the present specification in the context of individual example embodiments may be combined and implemented in a single example embodiment. On the contrary, various features described in the context of a single embodiment may be implemented in a plurality of example embodiments individually or in any appropriate sub-combination. Furthermore, although features may operate in a specific combination and may be initially depicted as being claimed, one or more features of a claimed combination may be excluded from the combination in some cases, and the claimed combination may be changed into a sub-combination or a modification of the sub-combination.

Likewise, although operations are depicted in a specific order in the drawings, it should not be understood that the operations must be performed in the depicted specific order or sequential order or all the shown operations must be performed in order to obtain a preferred result. In specific cases, multitasking and parallel processing may be advantageous. In a specific case, multitasking and parallel processing may be advantageous. In addition, it should not be understood that the separation of various device components of the aforementioned example embodiments is required for all the example embodiments, and it should be understood that the aforementioned program components and apparatuses may be integrated into a single software product or packaged into multiple software products.

The example embodiments disclosed in the present specification and the drawings are intended merely to present specific examples in order to aid in understanding of the present disclosure, but are not intended to limit the scope of the present disclosure. It will be apparent to those skilled in the art that various modifications based on the technical spirit of the present disclosure, as well as the disclosed example embodiments, can be made.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A service providing method, performed by an access card management server, using an access card, the service providing method comprising:
creating a plurality of access cards according to a request from an account of a partner terminal;
issuing, from among plurality of access cards, at least one access card to a user terminal;
receiving, from a service providing server, a confirmation request of the at least one access card issued to the user terminal, to provide an application service requested by the user terminal; and
transmitting information on the at least one access card issued to the user terminal to the service providing server,
wherein a filtering condition related to at least a portion of the plurality of access cards and requested by the account of the partner terminal is set to the application service, and
the application service is provided to the user terminal based on whether the at least one access card issued to the user terminal satisfies the filtering condition.

2. The service providing method of claim 1, wherein the filtering condition set to the application service comprises a condition related to at least one of:
whether the at least one access card issued to the user terminal satisfies an intersection condition of at least one access card set to the application service;
whether the at least one access card issued to the user terminal satisfies a union condition of at least one access card set to the application service; or
whether the at least one access card issued to the user terminal satisfies a complement condition of at least one access card set to the application service.

3. The service providing method of claim 1, wherein the filtering condition set to the application service is set to each of one or more detailed functions supported by the application service.

4. A service providing method, performed by a service providing server, using an access card, the service providing method comprising:
setting a filtering condition for an application service;
receiving a provision request of the application service from a user terminal;
transmitting, to an access card management server, a confirmation request of at least one access card issued to the user terminal;
receiving information on the at least one access card issued to the user terminal from the access card management server;
determining whether the at least one access card issued to the user terminal satisfies the filtering condition set to the application service; and
providing the application service to the user terminal based on whether the at least one access card issued to the user terminal satisfies the filtering condition set to the application service,
wherein the filtering condition, related to at least a portion of a plurality of access cards to which an account of the partner terminal has permission is set to the application service by a request from the account of the partner terminal.

5. The service providing method of claim 4, wherein the application service is a service subscribed by the partner terminal with the account, wherein the partner terminal subscribes to an access card issuance service with the account.

6. The service providing method of claim 4, wherein the filtering condition set to the application service comprises a condition related to at least one of:
whether the at least one access card issued to the user terminal satisfies an intersection condition of at least one access card set to the application service;
whether the at least one of access card issued to the user terminal satisfies a union condition of at least one access card set to the application service; or
whether the at least one access cards issued to the user terminal satisfies a complement condition of at least one access card set to the application service.

7. The service providing method of claim 4, wherein the filtering condition set to the application service is set to each of at least one detailed function supported by the application service.

8. The service providing method of claim 7, wherein the application service comprises a messaging service, and
the detailed function comprises at least one of (i) a function to enter a chatroom of the messaging service, (ii) a function to use a chatbot in a chatroom of the messaging service, (iii) a function to highlight a chat message in a chatroom, (iv) a function to post an announcement in a chatroom, (v) a function to search or share a search result in a chatroom, (vi) a function to share content in a chatroom, and (vii) a function to use an additional service accessible through the messaging service.

9. The service providing method of claim 7, wherein the application service comprises a video service, and
the detailed function comprises at least one of (i) a function to skip an advertisement inserted in the middle of a video, (ii) a function to share a video, (iii) a function to watch a video, and (iv) a function to download or edit a video.

10. The service providing method of claim 7, wherein the application service comprises a social network service, and
the detailed function comprises at least one of (i) a function to add a friend, (ii) a function to upload or download content, and (iii) a function to chat with a friend.

11. A service providing method, performed by a user terminal, using an access card, the service providing method comprising:
retaining at least one access card corresponding to an account of a partner terminal issued from an access card management server;
transmitting a provision request for an application service to a service providing server; and
receiving a provision response of the application service from the service providing server,
wherein a filtering condition related to an access card is set to the application service by a request from the account of the partner terminal, and
the application service is provided to the user terminal based on whether the at least one access card issued to the user terminal satisfies the filtering condition.

12. (canceled)

13. The service providing method of claim 1, wherein the filtering condition comprises at least one of retention of the at least a portion of the plurality of access cards, a combination of the at least a portion of the plurality of access cards, permission set to the at least a portion of the plurality of access cards, the number of the at least a portion of the plurality of access cards, or a type of the at least a portion of the plurality of access cards.

14. (canceled)

15. The service providing method of claim 4, wherein the filtering condition comprises at least one of retention of the at least a portion of the plurality of access cards, a combination of the at least a portion of the plurality of access cards, permission set to the at least a portion of the plurality of access cards, the number of the at least a portion of the plurality of access cards, or a type of the at least a portion of the plurality of access cards.

16. The service providing method of claim 1, wherein the application service comprises a messaging service, and
a service function of the application service comprises at least one of (i) a function to enter a chatroom of the messaging service, (ii) a function to use a chatbot in a chatroom of the messaging service, (iii) a function to highlight a chat message in the chatroom, or (iv) a function to post an announcement in the chatroom.

17. The service providing method of claim 1, wherein the application service comprises a video service, and
whether content of the video service is allowed to be watched in the user terminal is determined based on the access card issued to the user terminal.

18. The service filtering method of claim 1, wherein the application service comprises a social network service, and
whether content of the social network service is allowed to be viewed, uploaded, or downloaded in the user terminal is determined based on the access card issued to the user terminal.

19. (canceled)

20. The service providing method of claim 11, wherein the filtering condition comprises at least one of retention of an access card, a combination of access cards, permission set to an access card, the number of access cards, or a type of an access card.

21. The service providing method of claim 1, further comprising:
receiving, from the service providing server, a view request of a list of the plurality of access cards to which the account of the partner terminal has permission; and
transmitting the list of the plurality of access cards to which the account has permission to the service providing server.

22. The service providing method of claim 4, further comprising:
transmitting, to the access card management server, a view request of a list of the plurality of access cards to which the account has permission; and
receiving, from the access card management server, the list of the plurality of access cards to which the account has permission,
wherein the filtering condition is set using the list of the plurality of access cards.
